(19) United States
(12) Patent Application Publication
(10) Pub. No.: US 2022/0210467 A1
(43) Pub. Date: Jun. 30, 2022

(54) SYSTEM AND METHOD FOR FRAME RATE UP-CONVERSION OF VIDEO DATA BASED ON A QUALITY RELIABILITY PREDICTION

(71) Applicant: BEIJING DAJIA INTERNET INFORMATION TECHNOLOGY CO., LTD., Beijing (CN)

(72) Inventors: Yi-Wen Chen, San Diego, CA (US); Xianglin Wang, San Diego, CA (US); Shuiming Ye, San Diego, CA (US); Guoxin Jin, San Diego, CA (US); Shufei Fan, San Diego, CA (US); Bing Yu, Beijing (CN)

(73) Assignee: BEIJING DAJIA INTERNET INFORMATION TECHNOLOGY CO., LTD., Beijing (CN)

(21) Appl. No.: 17/561,165

(22) Filed: Dec. 23, 2021

Related U.S. Application Data
(60) Provisional application No. 63/132,475, filed on Dec. 30, 2020.

(51) Int. Cl. H04N 19/573; H04N 19/567; H04N 19/176; H04N 19/172; H04N 19/587

(52) U.S. Cl. CPC H04N 19/573; H04N 19/567; H04N 19/587; H04N 19/172; H04N 19/176

(57) ABSTRACT

According to one aspect of the disclosure, a computer-implemented method for performing frame rate up-conversion of video data including a sequence of image frames is provided. The method may include performing, by a video processor, an interpolation quality reliability prediction for a target image level based on a reliability metric. In response to the interpolation quality reliability prediction meeting a first reliability threshold condition associated with a first reliability threshold, the method may include performing, by the video processor, a motion-compensation interpolation at the target image level. In response to the interpolation quality reliability prediction not meeting the first reliability threshold, the method may include performing, by the video processor, a fallback interpolation at the target image level or performing a new interpolation quality reliability prediction for a new image level below the target image level.

### CROSS REFERENCE TO RELATED APPLICATION

This application claims the benefit of priority under 35 USC § 119(e) to U.S. Application No. 63/132,475, filed on Dec. 30, 2020, entitled “QUALITY RELIABILITY DETERMINATION FOR FRUC,” which is hereby incorporated by reference in its entirety.

### TECHNICAL FIELD

The present disclosure relates to the field of video processing, and more particularly relates to methods and systems for performing frame rate up-conversion (FRUC) of video data based on a quality reliability prediction.

### BACKGROUND

FRUC can be applied to improve visual quality of video data by converting an input video with a lower frame rate to an output video with a higher frame rate. For example, an input video with 30 frames per second (fps) can be converted into an output video with 60 fps, 120 fps, or another higher frame rate. Compared to the input video, the output video with a higher frame rate may provide smoother motion and a more pleasant viewing experience for a user.

FRUC can also be useful in low bandwidth applications. For example, some frames in a video may be dropped in an encoding process at a transmitter side so that the video can be transmitted with a lower bandwidth. Afterwards, the dropped frames can be re-generated through interpolation during a decoding process at a receiver side. For example, a frame rate of the video may be reduced by half by dropping every other frame in the encoding process at the transmitter side, and then at the receiver side, the frame rate may be recovered through frame interpolation using FRUC.

Existing FRUC methods can be mainly classified into three categories. The first category of methods interpolates additional frames using a number of received video frames without taking the complex motion model into account. The frame repetition method and the frame averaging methods are two typical examples of this category. In the frame repetition method, the frame rate is increased by simply repeating or duplicating the received frames. In the frame averaging method, additional frames are interpolated by weighted averaging of multiple received frames. Given the simplistic processing of these methods, the drawbacks of these methods are also obvious which include the production of motion jerkiness or blurring of moving objects when the video content contains moving objects with complex motion. The second category, the so-called motion compensated FRUC (MC-FRUC), is more advanced in that it utilizes the motion information to perform the motion compensation (MC) to generate the interpolated frames. The third category utilizes neural network. For example, through neural network and deep learning, a synthesis network may be trained and developed to produce interpolated frames, Motion field information, which is derived using either the conventional motion estimation or the deep learning-based approaches, may also be fed into the network for frame interpolation.

The interpolation quality of MC-based FRUC is highly related to the motion estimation accuracy of the input video. As a result, for video sequences with complex motions where motion estimation tends to be more error-prone, the interpolation quality is usually less reliable. For example, the interpolation quality on the video sequences with smooth panning are usually much more acceptable in terms of subjective quality than video sequences containing multiple occluded objects or other types of complex motions. When motion is estimated incorrectly, visible artifacts may show up in the interpolated frame.

The disclosure provides improved methods and systems that address the above-mentioned video artifact problem of MC-based FRUC when the interpolation quality is less reliable.

### SUMMARY

According to one aspect of the disclosure, a computer-implemented method for performing frame rate up-conversion of video data including a sequence of image frames is provided. The method may include performing, by a video processor, an interpolation quality reliability prediction for a target image level based on a reliability metric. In response to the interpolation quality reliability prediction meeting a first reliability threshold condition associated with a first reliability threshold, the method may include performing, by the video processor, a motion-compensation interpolation at the target image level. In response to the interpolation quality reliability prediction not meeting the first reliability threshold condition, the method may include performing, by the video processor, a fallback interpolation at the target image level or performing a new interpolation quality reliability prediction for a new image level below the target image level.

According to another aspect of the disclosure, a system for performing frame rate up-conversion of video data including a sequence of image frames is provided. The system may include a memory configured to store the sequence of image frames. The system may include a video processor coupled to the memory. The video processor may be configured to perform an interpolation quality reliability prediction for a target image level based on a reliability metric. In response to the interpolation quality reliability prediction meeting a first reliability threshold condition associated with a first reliability threshold, the video processor may be configured to perform a motion-compensation interpolation at the target image level. In response to the interpolation quality reliability prediction not meeting the first reliability threshold condition, the video processor perform a fallback interpolation at the target image level or performing a new interpolation quality reliability prediction for a new image level below the target image level.

According to yet another aspect of the disclosure, a non-transitory computer-readable storage medium configured to store instructions which, when executed by a video processor, cause the video processor to perform a process for performing frame rate up-conversion of video data including a sequence of image frames is provided. The process may include performing an interpolation quality reliability prediction for a target image level based on a reliability metric. In response to the interpolation quality reliability prediction meeting a first reliability threshold condition associated with a first reliability threshold, the process may include performing a motion-compensation interpolation at the target image level. In response to the interpolation quality reliability prediction not meeting the first reliability threshold condition, the process may include performing a fallback interpolation at the target image level or performing a new interpolation quality reliability prediction for a new image level below the target image level.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for performing FRUC of video data, according to embodiments of the disclosure.

FIG. 2A illustrates a block diagram of an exemplary process for performing FRUC of video data, according to embodiments of the disclosure.

FIG. 2B is a graphical representation illustrating an interpolation process of a target frame based on a plurality of reference frames, according to embodiments of the disclosure.

FIG. 3 is a flow chart of an exemplary method for performing FRUC of video data based on a interpolation quality reliability prediction, according to embodiments of the disclosure.

FIG. 4 is a flow chart of an exemplary method for performing the interpolation quality reliability prediction of FIG. 3 based on a block-level sum of an absolute difference (SAD) or a frame-level SAD, according to embodiments of the disclosure.

FIG. 5 is a flow chart of an exemplary method for performing the interpolation quality reliability prediction of FIG. 3 based on motion vectors (MVs), according to embodiments of the disclosure.

FIG. 6 is a flow chart of an exemplary method for performing the interpolation quality reliability prediction of FIG. 3 based on a foreground map, according to embodiments of the disclosure.

FIG. 7 is a flow chart of an exemplary method for performing the interpolation quality reliability prediction of FIG. 3 based on a motion vector (MV) variance, according to embodiments of the disclosure.

FIG. 8 is a flow chart of an exemplary method for performing the interpolation quality reliability prediction of FIG. 3 based on occlusion detection, according to embodiments of the disclosure.

FIG. 9 is a flow chart of an exemplary method for performing the interpolation quality reliability prediction of FIG. 3 based on pixel variation, according to embodiments of the disclosure.

FIG. 10 is a flow chart of an exemplary method for performing the interpolation quality reliability prediction of FIG. 3 based on an SAD size, according to embodiments of the disclosure.

FIG. 11 is a flow chart of an exemplary method for performing the interpolation quality reliability prediction of FIG. 3 based on multi-level reliability classification, according to embodiments of the disclosure.

FIG. 12 is a graphical representation illustrating a bilateral-matching motion estimation process, according to embodiments of the disclosure.

FIG. 13A is a graphical representation illustrating a forward motion estimation process, according to embodiments of the disclosure.

FIG. 13B is a graphical representation illustrating a backward motion estimation process, according to embodiments of the disclosure.

FIG. 14 is a graphical representation illustrating an exemplary motion vector scaling process, according to embodiments of the disclosure.

FIG. 15A is a graphical representation illustrating a process for generating an exemplary target object map, according to embodiments of the disclosure.

FIGS. 15B-15D are graphical representations illustrating a process for generating an exemplary reference object map based on the target object map of FIG. 15A, according to embodiments of the disclosure.

FIG. 15E is a graphical representation illustrating a process for determining an exemplary occlusion detection result for a target block based on the target object map of FIG. 15A, according to embodiments of the disclosure.

FIG. 16A is a graphical representation illustrating a process for determining a first occlusion detection result for a target block, according to embodiments of the disclosure.

FIG. 16B is a graphical representation illustrating a process for determining a second occlusion detection result for the target block of FIG. 16A, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

MC-FRUC techniques may include interpolating additional frames into the video using motion compensation of moving objects. Motion information of the moving objects may be utilized to perform motion compensation such that interpolated frames can be generated with smoother motion. Generally, an MC-FRUC system may include a motion estimation module, an occlusion detector, and a motion compensation module. The motion estimation module may determine motion vectors of an interpolated frame (also referred to as a target frame herein) relative to one or more reference frames based on a distortion metric. The occlusion detector may detect whether an occlusion scenario occurs in the target frame. Responsive to detecting that the occlusion scenario occurs, the occlusion detector may determine an occlusion area where the occlusion scenario occurs in the target frame.

In some implementations, through motion trajectory tracking, the occlusion detector may detect a non-occluded area, an occlusion area, or both, in the target frame. The motion compensation module may generate image content (or pixel values) for the non-occluded area by referencing both of a nearest previous frame (a reference frame immediately preceding the target frame) and a nearest next frame (a reference frame immediately subsequent to the target frame). The occlusion area can include, for example, a covered occlusion area, an uncovered occlusion area, or a combined occlusion area. For each of the covered occlusion area and the uncovered occlusion area, the motion compensation module may generate image content (or pixel values) for the area in the target frame by referencing either the nearest previous or the nearest next frame. To reduce blocking artifacts and improve visual quality, an overlapped block motion compensation (OBMC) technique may also be used.

For example, assuming that an area (e.g., a number of pixels or a block of pixels) in the target frame is detected to have a “covered” occlusion status relative to the nearest previous and next frames, which means that the area is revealed in the nearest previous frame but covered by one or more other objects in the nearest next frame. This area may be referred to as a covered occlusion area. For each target block in the area, no matched block (or no matched pixels) for the target block can be found in the nearest next frame. Only a corresponding reference block (or a corresponding block of pixels) in the nearest previous frame can be determined as a matched block and used for motion compensation of the target block.

In another example, assuming that an area in the target frame is detected to have an “uncovered” occlusion status, which means that the area is covered in the nearest previous frame but revealed in the nearest next frame. This area may be referred to as an uncovered occlusion area. For each target block in the area, no matched block can be found for the target block from the nearest previous frame. Only a corresponding reference block in the nearest next frame can be determined as a matched block and used for motion compensation of the target block.

In yet another example, assuming that an area is detected to have a combined occlusion status (e.g., a “covered-and-uncovered” occlusion status), which means that the area is covered (not revealed) in both the nearest previous frame and the nearest next frame. This area may be referred to as a combined occlusion area. For example, the area is covered by one or more first objects in the nearest previous frame and also covered by one or more second objects in the nearest next frame, such that the area is not revealed in both the nearest previous frame and the nearest next frame. For each target block in the area, no matched block can be found for the target block from the nearest previous frame and the nearest next frame. In this case, additional processing may be needed for interpolating pixels in the target block. For example, a hole filling method such as spatial interpolation (e.g., image inpainting) may be used to fill in the area.

However, the interpolation quality of MC-FRUC is highly related to the motion estimation accuracy of the input video. As a result, for video sequences with complex motions, where motion estimation tends to be more error-prone, the interpolation quality is usually less reliable. For example, the interpolation quality on the video sequences with smooth panning are usually more acceptable in terms of subjective quality than video sequences containing multiple occluded objects or other types of complex motions. When motion is estimated incorrectly, visible artifacts may show up in the interpolated frame. A video viewing experience can be degraded due to the visible artifacts, which may appear in the video as motion jerkiness or blurring of the moving objects. Thus, a proper handling of motion estimation for complex motions can be a challenge in FRUC in order to reduce or eliminate visible artifacts in interpolated frames.

To avoid such artifacts, in this disclosure, several systems and methods are disclosed to determine or predict the interpolation quality reliability. After the reliability of interpolation quality is determined, a fallback mechanism is invoked for those frames or blocks which are determined/predicted as not reliable in terms of their interpolation quality.

More specifically, according to the present disclosure, interpolation quality reliability may be first determined by the reliability determination module, then different interpolation processes may be applied according to the determined interpolation quality reliability. For example, 1) when the reliability of interpolation quality meets a reliability threshold condition, the normal interpolation process based on motion compensation is performed; and 2) when the reliability of interpolation quality is low (namely, when the reliability threshold condition is not met); a fallback interpolation mechanism is performed to avoid potential interpolation artifacts. Many different methods may be used as the fallback interpolation mechanism. Some examples of the fallback mechanism may include but are not limited to repeating the corresponding pixels from the original frames, or averaging the collocated samples from the reference frames, etc. As used herein, a reliability threshold condition may be met when a reliability metric and/or a value associated with a reliability metric is less than an associated reliability threshold, is equal to an associated reliability threshold, and/or is greater than an associated reliability threshold. The terms “threshold” and “threshold value” may be used interchangeably in the present disclosure.

Consistent with the disclosure, the interpolation quality reliability technique disclosed herein provides a specific, detailed solution for improving the video display quality when MC-FRUC is applied. The interpolation quality reliability technique may be implemented based on various reliability metrics. For example, the reliability metrics used to implement the present interpolation quality reliability technique may be related to any one or combination of: 1) a block-level or frame-level sum of the absolute difference (SAD), 2) block motion vectors (MVs) obtained during a motion estimation process, 3) foreground maps, 4) motion vector (MV) variance, 5) foreground MV variance, 6) occlusion detection, 7) block-level or frame-level activity, 8) a number of SAD blocks of a certain size, 9) a multi-level interpolation quality reliability determination, or 10) an adaptive reliability threshold selected based on the interpolation quality reliability technique, just to name a few. Further description for this specific, detailed solution for improving the video display quality when FRUC is applied is provided below in more detail.

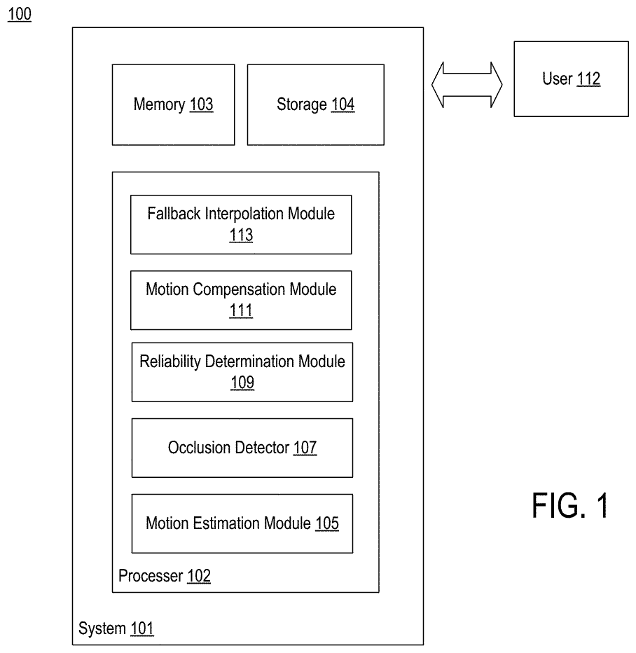

FIG. 1 illustrates a block diagram 100 of an exemplary system 101 for performing FRUC of video data, according to embodiments of the disclosure. In some embodiments, system 101 may be embodied on a device that a user 112 can interact with. For example, system 101 may be implemented on a server (e.g., a local server or a cloud server), a working station, a play station, a desktop computer, a laptop computer, a tablet computer, a smartphone, a game controller, a wearable electronic device, a television (TV) set, or any other suitable electronic device.

In some embodiments, system 101 may include at least one processor, such as a processor 102, at least one memory, such as a memory 103, and at least one storage, such as a storage 104. It is understood that system 101 may also include any other suitable components for performing functions described herein.

In some embodiments, system 101 may have different modules in a single device, such as an integrated circuit (IC) chip, or separate devices with dedicated functions. For example, the IC may be implemented as an application-specific integrated circuit (ASIC) or a field-programmable gate array (FPGA). In some embodiments, one or more components of system 101 may be located in a cloud computing environment or may be alternatively in a single location or distributed locations. Components of system 101 may be in an integrated device or distributed at different locations but communicate with each other through a network (not shown in the figure).

Processor 102 may include any appropriate type of microprocessor, graphics processor, digital signal processor, or microcontroller suitable for video processing. Processor 102 may include one or more hardware units (e.g., portion(s) of an integrated circuit) designed for use with other components or to execute art of a video processing program. The program may be stored on a computer-readable medium, and when executed by processor 102, it may perform one or more functions. Processor 102 may be configured as a separate processor module dedicated to performing FRUC. Alternatively, processor 102 may be configured as a shared processor module for performing other functions unrelated to performing FRUC.

In some embodiments, processor 102 can be a specialized processor customized for video processing. For example, processor 102 can be a graphics processing unit (GPU), which is a specialized electronic circuit designed to rapidly manipulate and alter memory to accelerate the creation of images in a frame buffer intended for output to a display device. Functions disclosed herein can be implemented by the GPU. In another example, system 101 can be implemented in a system on chip (SoC), and processor 102 may be a media and pixel processing (MPP) processor configured to run video encoder or decoder applications. In some embodiments, functions disclosed herein can be implemented by the MPP processor.

Processor 102 may include several modules, such as a motion estimation module 105, an occlusion detector 107, a reliability determination module 109, a motion compensation module 111, and a fallback interpolation module 113. Although FIG. 1 shows that motion estimation module 105, occlusion detector 107, reliability determination module 109, motion compensation module 111, and fallback interpolation module 113 are within one processor 102, they may be alternatively implemented on different processors located closely or remotely with each other.

Motion estimation module 105, occlusion detector 107, reliability determination module 109, motion compensation module 111, and fallback interpolation module 113 (and any corresponding sub-modules or sub-units) can be hardware units (e.g., portions of an integrated circuit) of processor 102 designed for use with other components or software units implemented by processor 102 through executing at least part of a program. The program may be stored on a computer-readable medium, such as memory 103 or storage 104, and when executed by processor 102, it may perform one or more functions.

Memory 103 and storage 104 may include any appropriate type of mass storage provided to store any type of information that processor 102 may need to operate. For example, memory 103 and storage 104 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 103 and/or storage 104 may be configured to store one or more computer programs that may be executed by processor 102 to perform functions disclosed herein. For example, memory 103 and/or storage 104 may be configured to store program(s) that may be executed by processor 102 to perform FRUC. Memory 103 and/or storage 104 may be further configured to store information and data used by processor 102.

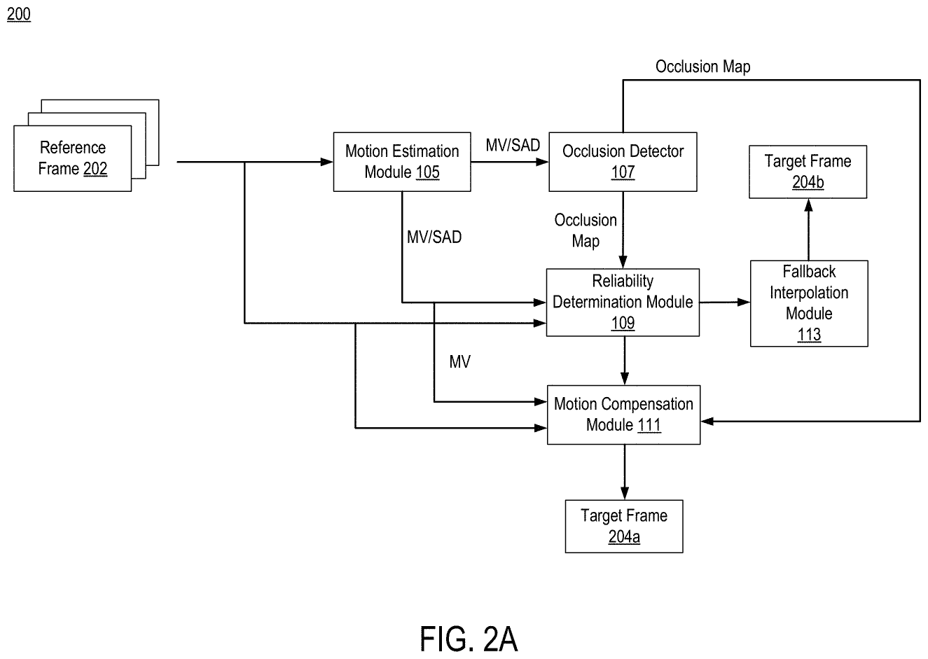

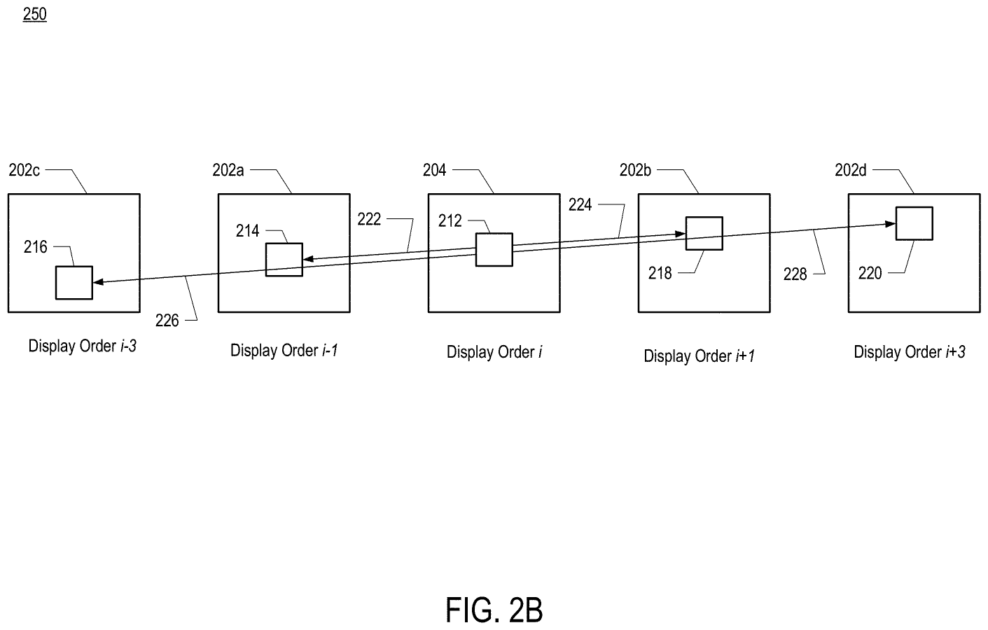

FIG. 2A illustrates a block diagram of an exemplary process 200 for performing FRUC of video data, according to embodiments of the disclosure. FIG. 29 is a graphical representation illustrating an interpolation process 250 of a target frame (e.g., a target frame 204) based on a plurality of reference frames, according to embodiments of the disclosure. The video data may include a sequence of image frames, and target frame 204 may be an interpolated frame to be inserted into the sequence of image frames. With combined reference to FIGS. 2A-2B, the object-based MC-FRUC technique disclosed herein may be implemented to generate target frame 204 using a plurality of reference frames 202. The plurality of reference frames 202 may include a plurality of original image frames in the video data that can be used for the generation and interpolation of target frame 204.

For example, as shown in FIG. 2B, the plurality of reference frames 202 may include a first previous frame 202a preceding target frame 204, a first next frame 202b subsequent to target frame 204, a second previous frame 202c preceding first previous frame 202a, and a second next frame 202d subsequent to first next frame 202b. Although four reference frames are shown in FIG. 2B, the number of reference frames used for the generation and interpolation of target frame 204 may vary depending on a specific application. Target frame 204 can be temporally located at a position with a display order (or time stamp) of i, where i is a positive integer. Second previous frame 202c, first previous frame 202a, first next frame 202b, and second next frame 202d may be located at positions with display orders of i−3, i−1, i+1, and i+3, respectively. Although not shown in FIG. 28, additional target frames may also be interpolated at positions with display orders of i−4, i−2, i+2, i+4, etc., respectively.

In some embodiments, target frame 204 may be divided into a plurality of target blocks with a size of N×M pixels per block, where N and M are positive integers. N indicates the number of pixels along a vertical direction in a target block, and M indicates the number of pixels along a horizontal direction in the target block. In some embodiments, each of the plurality of target blocks may have a variable block size (e.g., the block size is not fixed and can be varied depending on a specific application). Similarly, each reference frame 202 may be divided into a plurality of reference blocks with a size of N×M pixels per block.

Referring to FIG. 2A, motion estimation module 105 may be configured to receive the plurality of reference frames 202 and determine a set of motion vectors for target frame 204 relative to the plurality of reference frames 202. For example, for each target block in target frame 204, motion estimation module 105 may determine a plurality of motion vectors of the target block relative to the plurality of reference frames 202, respectively, as described below in more detail.

In some embodiments, the plurality of reference frames 202 may include a first previous frame preceding target frame 204 (e.g., first previous frame 202a immediately preceding target frame 204) and a first next frame subsequent to target frame 204 (e.g., first next frame 202b immediately subsequent to target frame 204). For each target block in target frame 204, motion estimation module 105 may determine a motion vector of the target block relative to the first previous frame and a motion vector of the target block relative to the first next frame.

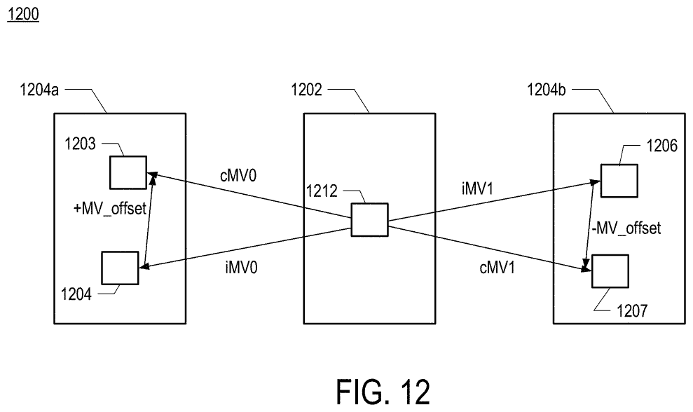

For example, referring to FIG. 2B, for a target block 212 of target frame 204, motion estimation module 105 may determine a motion vector 222 of target block 212 relative to first previous frame 202a and a motion vector 224 of target block 212 relative to first next frame 202b using an exemplary motion estimation technique described below with reference to FIG. 12, 13A, or 13B.

Moreover, motion estimation module 105 may also determine a distortion (e.g., SAD values) between the two corresponding reference blocks. For example, the SADs between pairs of two reference blocks which are related to a current block are calculated as the block-level SADs; and the block-level SADs of the whole frame may be accumulated as the frame-level SADs. In some embodiments, the SADs may be used by reliability determination module 109 to determine whether target frame 204 is interpolated by motion compensation module 111 or fallback interpolation module 113.

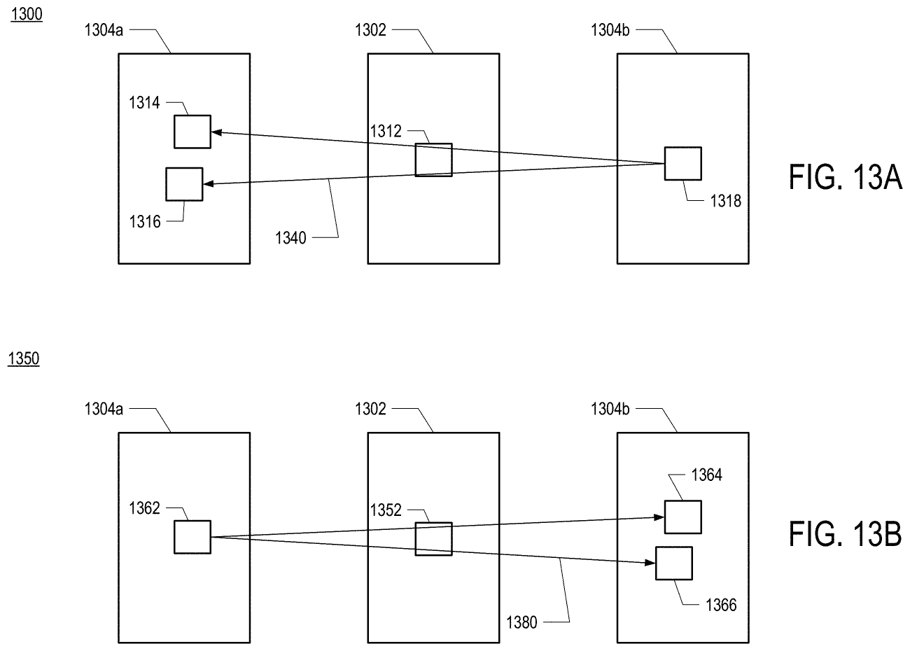

It is noted that these SADs may be of different types. For example, the first type of SAD is forward SAD which motion estimation module 105 may calculate by summing up the value differences between the corresponding samples of the collocated block in the next reference frame and the reference block in the previous reference frame as illustrated in FIG. 13A, The block SAD may be calculated using the following procedure (1):

blk_sad[i][j] =0
for (y= 0; y< block_height; y++)
{
for (x= 0; x< block_width; x++)

| | |
|---|---|
| { | (1), |

```
      blk_sad[i][j] +=
      abs(pic1[i*block_width+x][j*block_height+y]−
        pic2[i*block_width+x+mv_x][j*block_height+y+mv_y])
    }
  }
```

where blk_sad[i][j] is the SAD of the block with the block index (i, j), blk_width and blk_height are the width and height of a block, pic1[x][y] is the pixel at the position (x, y) of the next reference frame, pic2[x][y] is the pixel at the position (x, y) of the previous reference frame, mv_x and mv_y are respectively the x and y component of the forward motion vector searched by the forward motion estimation process. abs(x) is a function which derives the absolute value of x. In our scheme, the position of the top-left, block of one picture (or frame) is indexed as (0,0) while the bottom-right block of the frame is indexed as (img_wd/blk_wd−1, img_ht/blk_ht−1), where img_wd and img_ht are the width and height of the frame respectively.

The frame-level SADs may be calculated by accumulating all the SADs for all the blocks as follows using procedure (2):

| frame_sad =0 | |
|---|---|
| for (j= 0; j< (img_ht/blk_ht); j++) | |
| { | |
| for (i= 0; i< (img_wd/blk_wd); i++) | (2). |

```
  {
    frame_sad += blk_sad [i][j]
    }
  }
```

Backward SAD may be defined similar to forward SAD, but in a symmetrical manner. For example, backward SAD may be calculated by summing up the value differences between the samples of the collocated block in the previous reference frame and the corresponding reference block in the next reference frame as illustrated in FIG. 13B.

A third type SAD is called bilateral SAD. Bilateral SAD may be calculated by summing up the value differences between the corresponding samples of a reference block in the previous reference frame and a reference block in the next reference frame as illustrated in FIG. 12. Based on a certain motion vector, these two reference blocks are located symmetrically with reference to the current block. The bilateral SAD of one block may be calculated using the following procedure (3):

blk_sad[i][j] =0
for (y= 0; y< block_height; y++)
{
for (x= 0; x< block_width; x++)

| | |
|---|---|
| { | (3), |

```
    blk_sad[i][j] +=
    abs(pic1[i*block_width+x−mv_x/2][j*block_height+y−mv_y/2]−
      pic2[i*block_width+x+mv_x/2][j*block_height y+mv_y/2])
    }
  }
```

where blk_sad[i][j] is the SAD of the block with the block index (i, j), blk_width and blk_height are the width and height of a block, pic1[x][y] is the pixel at the position (x, y) of the next reference frame, pic2[x][y] is the pixel at the position (x, y) of the previous reference frame, mv_x and mv_y are respectively the x and y component of the bilateral motion vector searched by the bilateral motion estimation process, and abs(x) is a function which derives the absolute value of x.

The SADs calculated by motion estimation module 105 may be input into, among others, reliability determination module 109. Reliability determination module 109 may compare these SADs to a reliability threshold that may be associated with SADs, e.g., determining whether these SADs meet a reliability threshold condition associated with the reliability threshold. When the SADs received from motion estimation module 105 meet the reliability threshold condition, reliability determination module 109 may activate or signal to motion compensation module 111 to interpolate target frame 204 based on a motion-compensation procedure. On the other hand, when the SADs do not meet the reliability threshold condition, reliability determination module 109 may activate or signal to fallback interpolation module 113 so that target frame 204 is interpolated using a fallback interpolation procedure rather than the motion-compensation procedure.

In some embodiments, depending on the type of SAD calculated by motion estimation module 105, motion estimation module 105 may derive block motion vectors (MVs) based on a motion estimation process, e.g., such as forward motion estimation (ME), backward ME, and/or bilateral ME. The type of ME process corresponds to the type of SAD calculated. For example, forward MF may refer to the motion estimation process where the forward SAD is used as the distortion metric. Likewise, backward ME and bilateral ME may refer to the motion estimation process where the backward SAD and bilateral SAD are respectively used. Motion estimation module 105 may send the block MVs calculated based on one or more of forward ME, backward ME, and/or bilateral ME to reliability determination module 109, which may compare the block MVs to a reliability threshold, e.g., determining whether the block MVs meet a reliability threshold condition associated with the reliability threshold. When the block MVs meet the reliability threshold condition, reliability determination module 109 may activate or signal to motion compensation module 111 to interpolate target frame 204 based on a motion-compensation procedure. On the other hand, when the block MVs do not meet the reliability threshold condition, reliability determination module 109 may activate or signal to fallback interpolation module 113 so that target frame 204 is interpolated using a fallback interpolation procedure rather than the motion-compensation procedure.

In some embodiments, the plurality of reference frames 202 may further include one or more second previous frames preceding the first previous frame (e.g., second previous frame 202c immediately preceding first previous frame 202a) and one or more second next frames subsequent to the first next frame (e.g., second next frame 202d immediately subsequent to first next frame 202b). For each target block in target frame 204, motion estimation module 105 may be further configured to scale the motion vector of the target block relative to the first previous frame to generate a corresponding motion vector of the target block relative to each second previous frame. Also, motion estimation module 105 may be further configured to scale the motion vector of the target block relative to the first next frame to generate a corresponding motion vector of the target block relative to each second next frame.

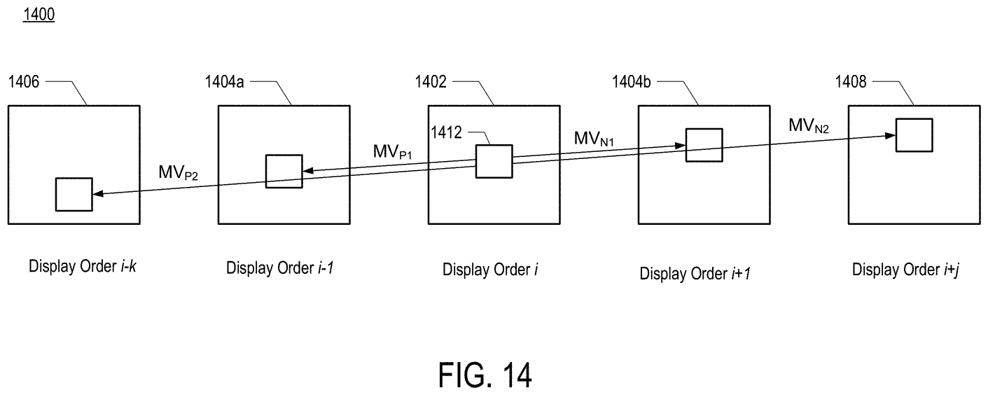

For example, referring to FIG. 2B, motion estimation module 105 may scale motion vector 222 of target block 212 relative to first previous frame 202a to generate a motion vector 226 of target block 212 relative to second previous frame 202c. Also, motion estimation module 105 may scale motion vector 224 of target block 212 relative to first next frame 202b to generate a motion vector 228 of target block 212 relative to second next frame 202d. An exemplary motion vector scaling process is described below in more detail with reference to FIG. 14.

Occlusion detector 107 may be configured to receive the set of motion vectors of target frame 204 from motion estimation module 105 and perform a motion vector classification on the set of motion vectors to generate a foreground map for target frame 204 based on a target object map for target frame 204, as described below in more detail.

In some embodiments, occlusion detector 107 may perform a motion vector classification on the set of motion vectors to detect one or more objects in target frame 204. For example, occlusion detector 107 may classify the set of motion vectors into one or more groups of motion vectors. In this case, similar motion vectors (e.g., motion vectors with an identical or a similar velocity) can be classified into the same group. For example, a k-nearest neighbor (k-NN) algorithm can be used to perform the motion vector classification. Then, for each group of motion vectors, occlusion detector 107 may determine one or more target blocks from target frame 204, each of which has a respective motion vector being classified into the group of motion vectors. Occlusion detector 107 may determine an object corresponding to the group of motion vectors to be an image area including the one or more target blocks of target frame 204. By performing similar operations for each group of motion vectors, occlusion detector 107 may determine one or more objects corresponding to the one or more groups of motion vectors.

Consistent with the disclosure, two motion vectors can be considered as similar motion vectors if a difference between their velocities is within a predetermined threshold. For example, if an angle difference and an amplitude difference between velocities of two motion vectors are within a predetermined angle threshold and a predetermined amplitude threshold, respectively, then the two motion vectors can be considered as similar motion vectors. The predetermined angle threshold can be normalized value, such as ±5%, ±10?, ±15%, or another suitable value. The predetermined amplitude threshold can also be a normalized value, such as ±5%, ±10%, ±15%, or another suitable value.

Consistent with the disclosure, an object can be an image area of the image frame with identical or similar motion vectors. An object disclosed herein may include multiple real-world objects. For example, multiple real-world objects may be detected as a background object in an object map if these real-world objects have a zero-motion vector.

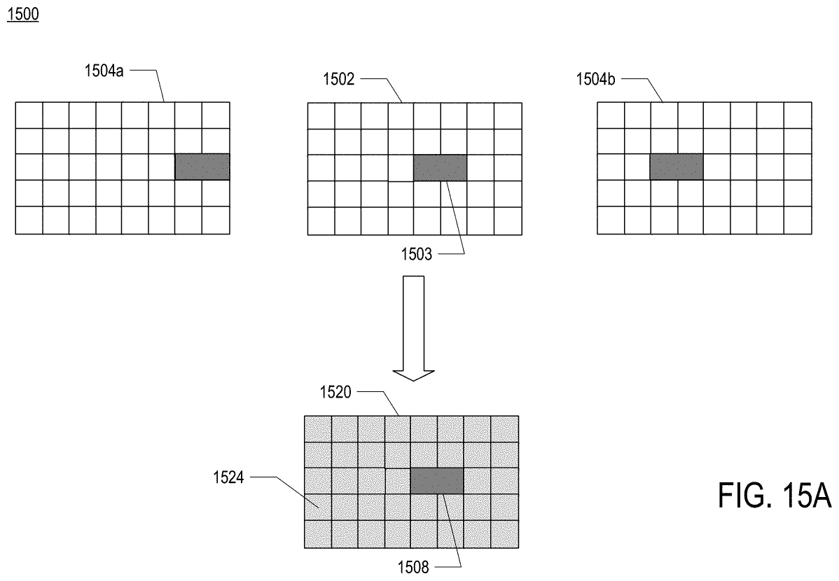

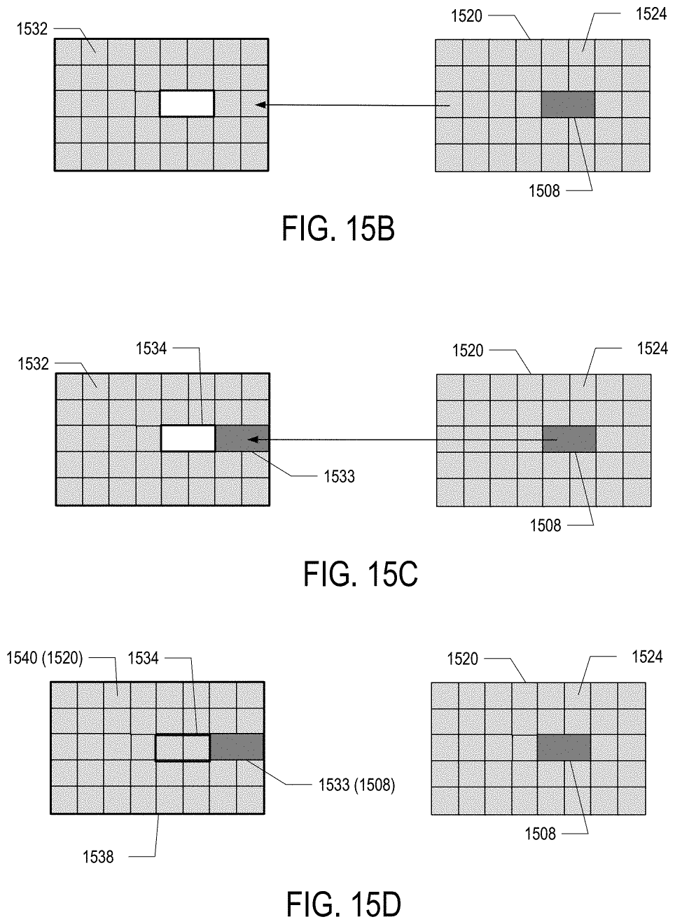

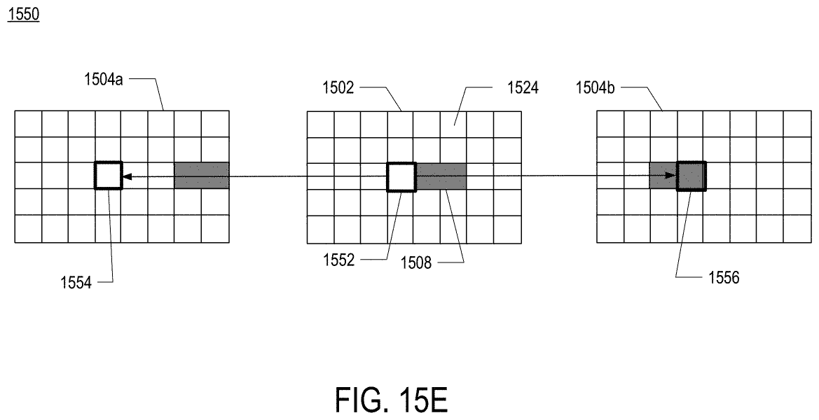

In some embodiments, occlusion detector 107 may generate a target object map for target frame 204 to include the one or more objects detected in target frame 204. For example, the target object map may depict the one or more objects and indicate which of the one or more objects each target block of target frame 204 belongs to. The generation of an exemplary target object map is described below in more detail with reference to FIG. 15A.

In some embodiments, occlusion detector 107 may determine one or more relative depth values of the one or more objects in the target object map. For example, the one or more relative depth values of the one or more objects can be determined based on one or more features of these objects. A feature of an object can be, for example, a size (e.g., indicated by an area) of the object, an average magnitude of a motion vector of the object, etc. The one or more relative depth values of the one or more objects can be used as a measurement to indicate which object is relatively closer to a camera. Specifically, a smaller relative depth value of an object indicates that the object s closer to the camera than e object with a larger relative depth value. These depth values may be used to generate the foreground map, which indicates each block of target frame 204 that corresponds to either the foreground area or the background area.

For example, the object map indicates a correlation between an object (or motion vector group) and a target block in target frame 204. An example is illustrated in FIG. 15A where two objects are detected in target frame, one has zero motion and the other object moves toward left. It is worth noting that an “object” referred here in the disclosure is essentially an image area in a frame with similar motion vectors and may contain multiple real-world objects. In one exemplary method of the disclosure, it may be assumed that the object with the largest area is the background area, and areas other than the detected background are regarded as foreground area. As shown in the example in FIG. 15A, object 1 with zero motion has the largest area size and therefore is considered as the background area; the object 2 is considered as the foreground. As mentioned earlier, the background area may contain multiple real-world objects that share similar motion vectors. Once both the background and the foreground areas are designated, a foreground map is naturally derived.

In some embodiments, the foreground maps of each interpolated frame and reference frame may be first derived. The statistical data of the foreground maps can be further generated for the determination of the interpolation quality reliability. Such statistical data include but are not limited to foreground detection reliability and/or foreground MV reliability.

To determine the foreground detection reliability, reliability determination module 109 may classify a foreground block into an aligned or mis-aligned foreground block. When the current block is a foreground block and its corresponding block in the reference frame is also a foreground block, the current block is marked as aligned foreground block; otherwise it is marked as mis-aligned foreground block. Besides, for each foreground block, the number of foreground blocks (local_blk_fg_count) and the number of non-foreground blocks (local_blk non fg_count) within a local area around the current block could also be used for the determination of the interpolation quality reliability. In some embodiments, reliability determination module 109 may identify a frame of the foreground map as reliable when the numbers of mis-aligned foreground block is less than a threshold (a reliability threshold). In some embodiments, reliability determination module 109 the difference between the number of foreground blocks in the reference frame and the number of foreground block in the current frame is also less than another threshold.

The foreground MV reliability may indicate how reliable the MVs of a foreground block are. In some embodiments, the foreground MV reliability may be calculated based on the difference between the MVs of the current foreground block and the MVs of the current block's corresponding block in the reference frames. For example, the foreground MV reliability is higher when the difference is lower. When the foreground MV reliability meets the reliability threshold condition, reliability determination module 109 may activate or signal to motion compensation module 111 to interpolate target frame 204 based on a motion-compensation procedure. On the other hand, when the foreground MV reliability does not meet the reliability threshold condition, reliability determination module 109 may activate or signal to fallback interpolation module 113 so that target frame 204 is interpolated using a fallback interpolation procedure rather than the motion-compensation procedure.

In some embodiments, reliability determination module 109 may derive and use two types of MV variance to determine whether the target frame is interpolated by motion-compensation interpolation procedure or a fallback interpolation procedure. Spatial MV variance may be derived to measure the spatial variation of the MVs around the current block. In some embodiments, spatial MV variance may be calculated as the summation of the MV difference between the current block and its spatial neighboring blocks (e.g., the one to the left and the one on the top of current block), such as according to procedure (4):

sp_mv_var[x][y]+=abs(cur_mv_x[x][y]−cur_mv_x[x−1][y])+abs(cur_mv_y[x][y]−cur_mv_v[x−1][y])+abs(cur_mv_x[x][y]−cur_mv_x[x−1][y])+abs(cur_mv_y[x][y]−cur_mv_y[x−1][y]) (4).

The frame level spatial my variance may be calculated by accumulating all the blocks' spatial MV variance, such as according to procedure (5):

| sp_frame_mv_var =0 | |
|---|---|
| for (y= 0; y< (img_ht/blk_ht); y++) | |
| { | |
| for (x= 0; x< (img_wd/blk_wd); x++) | (5). |

```
  {
    sp_frame_mv_var += sp_mv_var[x][y]
  }
}
```

Temporal MV variance may be derived to measure the temporal variation of the MVs around the current block. In some embodiments, the temporal MV valiance may be calculated as the summation of the MV difference between the current block and its corresponding blocks in the reference frames, such as according to procedure (6):

tmp_mv_var[x][y]+=abs(cur_mv_x[x][y]−ref_mv_x[x][y])+abs(cur_mv_y[x][y]−ref_mv_y[x][y]) (6).

The frame level temporal MV variance may be calculated by accumulating all the blocks' temporal MV variance, such as according to procedure (7):

| tmp_frame_mv_var =0 | |
|---|---|
| for (y= 0; y< (img_ht/blk_ht); y++) | |
| { | |
| for (x= 0; x< (img_wd/blk_wd); x++) | (7). |

```
    {
    tmp_frame_mv_var += tmp_mv_var[x][y]
  }
  }
```

In some embodiments, reliability determination module 109 may calculate foreground MV variances using the same or similar techniques to those described above in connection MV variances (e.g., procedures (5)-(7)). When the foreground MV variances meets the reliability threshold condition, reliability determination module 109 may activate or signal to motion compensation module 111 to interpolate target frame 204 based on a motion-compensation procedure. On the other hand, when the foreground MV variances do not meet the reliability threshold condition, reliability determination module 109 may activate or signal to fallback interpolation module 113 to interpolate target frame 204 based on a fallback interpolation procedure.

In some embodiments, occlusion detector 107 may identify an object with the largest area in target frame 204 as a background area (a background object) and assign this object with the largest relative depth value. Any other object detected in target frame 204 can be assigned with a respective relative depth value that is smaller than that of the background object and identified as the foreground area. For example, one or more other objects detected in target frame 204 can be assigned with an identical relative depth value which is smaller than that of the background object. In another example, one or more other objects detected in target frame 204 can be assigned with one or more different relative depth values which are smaller than that of the background object. When any other object overlaps with the background object, the other object can be determined to cover the background object.

Since each object can be assigned with a relative depth value, target blocks included in the same object are assigned with the relative depth value of the object. In other words, each target block included in the object may have the same relative depth value as the object. Thus, the target object map of target frame 204 can be used to indicate a corresponding relative depth value of each target block in target frame 204. That is, a corresponding relative depth value of each target block can be found from the target object map, which is useful for determining an occlusion detection result of the target block.

In some embodiments, occlusion detector 107 may perform an object projection process to project the target object map onto the plurality of reference frames 202 based on the set of motion vectors of target frame 204 and generate a plurality of reference object maps for the plurality of reference frames 202 thereof.

For example, for each reference frame 202, occlusion detector 107 may project each object of target frame 204 onto the reference frame 202 to generate an object projection on the reference frame 202. Specifically, occlusion detector 107 may project each target block of the object onto reference frame 202 to generate a block projection of the target block based on a motion vector of the target block relative to reference frame 202. Then, block projections of all target blocks of the object may be generated and aggregated to form the object projection for the object. By performing similar operations to project each object identified in the target object map onto reference frame 202, occlusion detector 107 may generate one or more object projections for the one or more objects on reference frame 202.

For an image area of reference frame 202 that is only covered by an object projection, occlusion detector 107 may determine that the image area of reference frame 202 is covered by an object associated with the object projection. As a result, the object is identified in a reference object map of reference frame 202. Each reference block in the image area may have the same relative depth value as the object.

Alternatively or additionally, for an image area of reference frame 202 where two or more object projections overlap, an object projection associated with an object with a smaller (or smallest) relative depth value is selected. For example, the two or more object projections are associated with two or more objects, respectively. Occlusion detector 107 may determine a set of relative depth values associated with the two or more objects from the target object map and a minimal relative depth value among the set of relative depth values. Occlusion detector 107 may identify, from the two or more object projections, an object projection associated with an object having the minimal relative depth value. The object with the smaller (or smallest) relative depth value can be equivalent to the object having the minimal relative depth value from the two or more objects.

Occlusion detector 107 may determine that the image area of reference frame 202 is covered by the object with the smaller (or smallest) relative depth value. As a result, the object with the smaller (or smallest) relative depth value can be identified in the reference object map of reference frame 202. Each reference block in the image area may have the same relative depth value as the object in the reference object map. The generation of an exemplary reference object map is also described below in more detail with reference to EEGs. 15B-150.

In another example, for each reference frame 202, occlusion detector 107 may project the plurality of target blocks onto reference frame 202 to generate a plurality of block projections based on motion vectors of the plurality of target blocks relative to reference frame 202, respectively. That is, occlusion detector 107 may project each target block onto reference frame 202 to generate a block projection based on a motion vector of the target block relative to reference frame 202. Occlusion detector 107 may combine the plurality of block projections to generate a reference object map for reference frame 202 based at least in part on the target object map. Specifically, for a reference block of reference frame 202 that is only covered by a block projection of a target block, occlusion detector 107 may determine that the reference block is covered by an object associated with the target block. As a result, the object associated with the target block is identified in the reference object map of reference frame 202. The reference block may have the same relative depth value as the object.

Alternatively or additionally, for a reference block of reference frame 202 where two or more block projections of two or more target blocks overlap, a block projection associated with a target block having a smaller (or smallest) relative depth value is selected. For example, the two or more block projections are associated with the two or more target blocks, respectively. Occlusion detector 107 may determine a set of relative depth values associated with the two or more target blocks from the target object map and a minimal relative depth value among the set of relative depth values. Occlusion detector 107 may identify, from the two or more block projections, a block projection associated with a target block having the minimal relative depth value. The target block with the smaller (or smallest) relative depth value can be equivalent to the target block having the minimal relative depth value from the two or more target blocks.

Occlusion detector 107 may determine that the reference block is covered by an object associated with the target block having the smaller (or smallest) relative depth value. As a result, the object associated with the target block having the smaller (or smallest) relative depth value is identified in the reference object map of reference frame 202. The reference block may have the same relative depth value as the target block having the smaller (or smallest) relative depth value.

As a result, the reference object map for reference frame 202 can be generated. The plurality of reference blocks in reference frame 202 can be determined to be associated with one or more objects identified in the reference object map, respectively. It is noted that the objects identified in the reference object map may or may not be identical to the objects identified in the target object maps. For example, some objects identified in the target object map may not be present in the reference object map. In another example, all objects identified in the target object map may be present in the reference object map. Since each object identified in the reference object map can be associated with a relative depth value, reference blocks included in the same object can be associated with the same relative depth value of the object. Thus, the reference object map can be used to indicate a corresponding relative depth value of each reference block in reference frame 202. For example, a corresponding relative depth value of each reference block can be found from the reference object map, which is useful for determining occlusion detection results of target blocks as described below in more detail.

In some embodiments, occlusion detector 107 may detect an occlusion area in target frame 204 based on the set of motion vectors, the target object map, and the plurality of reference object maps for the plurality of reference frames 202. For example, occlusion detector 107 may detect a set of occluded target blocks from a plurality of target blocks in target frame 204 and generate an occlusion area for target frame 204 including the set of occluded target blocks.

In some implementations, the plurality of reference frames 202 may include a first previous frame preceding target frame 204 and a first next frame subsequent to target frame 204, and the plurality of reference object maps for the plurality of reference frames 202 may include a first previous object map for the first previous frame and a first next object map for the first next frame. For each target block in target frame 204, occlusion detector 107 may determine a first occlusion detection result for the target block. The first occlusion detection result may indicate whether the target block is an occluded target block relative to the first previous and next frames.

For example, occlusion detector 107 may determine, based on a motion vector of the target block relative to the first previous frame, a first previous block of the first previous frame that corresponds to the target block. Occlusion detector 107 may determine a relative depth value of the first previous block based on the first previous object map. Next, occlusion detector 107 may determine, based on a motion vector of the target block relative to the first next frame, a first next block of the first next frame that corresponds to the target block. Occlusion detector 107 may determine a relative depth value of the first next block based on the first next object map. Then, occlusion detector 107 may determine the first occlusion detection result for the target block based on a relative depth value of the target block, the relative depth value of the first previous block, and the relative depth value of the first next block.

If the relative depth value of the target block is not greater than the relative depth value of the first previous block and is greater than the relative depth value of the first next block (e.g., a covered occlusion condition is satisfied), occlusion detector 107 may determine that the target block is an occluded target block having a covered occlusion status relative to the first previous and next frames. For example, the target block may be a covered occlusion target block relative to the first previous and next frames, such that the target block is revealed in the first previous frame but covered by an object with a smaller relative depth value in the first next frame, A matched block of the target block can be the first previous block in the first previous frame.

If the relative depth value of the target block is greater than the relative depth value of the first previous block and not greater than the relative depth value of the first next block (e.g., an uncovered occlusion condition is satisfied), occlusion detector 107 may determine that the target block is an occluded target block having an uncovered occlusion status relative to the first previous and next frames. For example, the target block may be an uncovered occlusion target block relative to the first previous and next frames, such that the target block is covered by an object with a smaller relative depth value in the first previous frame but revealed in the first next frame, A matched block of the target block can be the first next block in the first next frame.

If the relative depth value of the target block is greater than the relative depth value of the first previous block and also greater than the relative depth value of the first next block (e.g., a combined occlusion condition is satisfied), occlusion detector 107 may determine that the target block is an occluded target block having a combined occlusion status relative to the first previous and next frames. For example, the target block may be a combined occlusion target block relative to the first previous and next frames, such that the target block is covered by a first object in the first previous frame and a second object in the first next frame. Each of the first and second objects may have a relative depth value smaller than that of the target block. The first and second objects can be the same object or different objects. No matched block can be found for the target block from the first previous frame and the first next frame.

Otherwise (e.g., none of the covered occlusion condition, the uncovered occlusion condition, and the combined occlusion condition is satisfied), occlusion detector 107 may determine that the target block is a normal target block. For example, the target block is revealed in the first previous and next frames. Matched blocks of the target block may include the first previous block in the first previous frame and the first next block in the first next frame.

In other words, occlusion detector 107 may determine whether the target block is a non-occluded target block, a covered occlusion target block, an uncovered occlusion target block, or a combined occlusion target block based on the following expression (8):

$$occlusion ( k , P 1 , N 1 ) = \{ \begin{matrix}covered & if {D}_{k} \leq {D}_{R ( k , P 1 )} and {D}_{k} > {D}_{R ( k , N 1 )} \\ uncovered & if {D}_{k} > {D}_{R ( k , P 1 )} and {D}_{k} \leq {D}_{R ( k , N 1 )} \\ combined & if {D}_{k} > {D}_{R ( k , P 1 )} and {D}_{k} > {D}_{R ( k , N 1 )} \\ normal & otherwise\end{matrix} \qquad ( 8 )$$

In the above expression (8), k denotes an index of the target block, occlusion(k, P1, N1) denotes a first occlusion detection result of the target block k relative to the first previous frame P1 and the first next frame N1, Dₖ denotes a relative depth value of the target block k, D_{R(k,P1)} denotes a relative depth value of a first previous block R(k, P1) corresponding to the target block k from the first previous frame P1, and D_{R(k,N1)} denotes a relative depth value of a first next block R(k, N1) corresponding to the target block k from the first next frame N1. The first previous block R(k, P1) can be determined by projecting the target block k to the first previous frame P1 based on a motion vector of the target block k relative to the first previous frame P1. The first next block R(k, N1) can be determined by projecting the target block k to the first next frame N1 based on a motion vector of the target block k relative to the first next frame N1.

In the above expression (8), a “covered” result represents that the target block k is a covered occlusion target block, and a matched block of the target block k can be found in the first previous frame P1, which is the first previous block R(k, P1). An “uncovered” result represents that the target block k is an uncovered occlusion target block, and a matched block of the target block k can be found in the first next frame N1, which is the first next block R(k, N1). A “combined” result represents that the target block k is a combined occlusion target block, and no matched block of the target block k can be found in the first previous frame P1 and the first next frame N1. A “non-occluded” result represents that the target block k is a non-occluded target block, and two matched blocks of the target block k can be found in the first previous frame P1 and the first next frame N1, respectively, which include the first previous block R(k, P1) and the first next block R(k, N1).

Based on the above expression (8), the relative depth values of the target block k and its corresponding reference blocks R(k, P1) and R(k, N1) can be compared to determine whether the target block k is occluded in the corresponding reference frames N1 and P1. The “covered,” “uncovered,” “combined,” or “normal” result can then be determined based on whether the target block k is occluded when projected onto the reference frames N1 and P1.

In some embodiments, reliability determination module 109 may use blocks classified as “covered,” “uncovered,” and/or “covered-and-uncovered” for the interpolation quality reliability determination. In other words, reliability determination module 109 may use the blocks not classified as “normal” for the interpolation quality reliability determination. For example, the numbers of blocks that are not classified as “normal” (local_blk_occ_count) within a local area of the current block could also be used for the determination of the interpolation quality reliability, which may be calculated as follows according to procedure (9):

local_blk_occ_count[i][j] = 0
for (y= −n; y< n; y++)
{

| | |
|---|---|
| for (x= −n; x< n; x++) | (9). |

```
  {
  local_blk_occ_count[i][j] += (blk_occ_type[i][j] = = normal? 0:1)
  }
}
```

When the number of blocks not classified as “normal” meets the reliability threshold condition, reliability determination module 109 may activate or signal to motion compensation module 111 to interpolate target frame 204 based on a motion-compensation procedure. On the other hand, when the number of blocks not classified as “normal” does not meets the reliability threshold condition, reliability determination module 109 may activate or signal to fallback interpolation module 113 to interpolate target frame 204 based on a fallback interpolation procedure.

In some embodiments, reliability determination module 109 may derive the activity of one block to measure the local variation of pixels within the block, an example calculation of block activity is illustrated below as procedure (10):

act=min_act_value
for (y= blk_topleft_y; y< (blk_topleft_y +block_height); y++)
{

| | |
|---|---|
| for (x= blk_topleft_x; x< (blk_topleft_x +block_width); x++) | (10), |

```
  {
  act+= abs(pic[x][y]− pic[x−1][y]) + abs(pic[x][y]− pic[x][y−1])
  }
}
```

where act is the activity of the current block, blk_topleft_x and blk_topleft_y are the coordinate position of the top-left pixel of the current block, blk_width and blk_height are the width and height of the current block, pic[x][y] is the value of the pixel at the position (x, y) of the current picture. abs(x) is a function which derives the absolute value of x. Here, the position of the top-left pixel of one picture (or frame) is indexed as (0,0) while the bottom-right pixel is indexed as (blk_width−1, blk_height−1).

When the local variation of pixels within the block meets the reliability threshold condition, reliability determination module 109 may activate or signal to motion compensation module 111 to interpolate target frame 204 based on a motion-compensation procedure. On the other hand, when the local variation of pixels within the block does not meets the reliability threshold condition, reliability determination module 109 may activate or signal to fallback interpolation module 113 to interpolate target frame 204 based on a fallback interpolation procedure.

In some embodiments, reliability determination module 109 may determine whether the size of SAD blocks (e.g., large-SAD blocks) meets a size threshold, and then whether the number of SAD blocks meets the size threshold meets the reliability threshold condition. When the number of large-SAD blocks meets the reliability threshold condition, reliability determination module 109 may activate or signal to motion compensation module 111 to interpolate target frame 204 based on a motion-compensation procedure. On the other hand, when the number of large-SAD blocks does not meet the reliability threshold condition, reliability determination module 109 may activate or signal to fallback interpolation module 113 to interpolate target frame 204 based on a fallback interpolation procedure.

In some embodiments, reliability determination module 109 may perform a level interpolation quality reliability determination process to determine interpolation quality reliability from a higher level to a lower level. The levels from highest to lowest may include 1) video sequence level, 2) frame level, 3) frame region level and/or 4) block level.

At each level, the determination of interpolation quality reliability could be classified into different interpolation quality reliability categories. In one scheme, the reliability is classified into “high reliability”, “medium reliability” and “low reliability.” At a certain level, if the interpolation quality reliability is classified into the “high reliability” category, reliability, determination module 109 does not perform further checking below the current level, and the motion-compensation interpolation process is performed for all the pixels at the current level. At certain level if the interpolation quality reliability is classified into “low reliability,” reliability determination module 109 does not perform further checking below the current level, and a fallback interpolation process is performed for all the pixels at the current level. At certain level if the interpolation quality reliability is classified into “medium reliability,” reliability determination module 109 performs interpolation quality reliability determination at the next lower level. For the lowest level, only two categories, “high reliability” and “low reliability,” are available. For example, if a frame is classified as “reliable” in terms of interpolation quality, the motion-compensation interpolation process is performed for all the pixels in the frame and no further checking is needed at frame region or block level.

According to the disclosure, the statistical data and metadata (reliability metrics) as described in previous sections could be jointly used to determine the interpolation quality reliability. In one example, only one-level reliability determination at frame level is performed, and the weighted sum of the frame-level SADs and the frame-level MV variance are calculated for each to-be-interpolated frame. When the weighted sum is larger than a threshold (e.g. T1), the interpolation quality reliability of the whole frame is regarded by reliability determination module 109 as “low reliability” and a fallback interpolation process is performed to avoid the interpolation artifacts. Otherwise when the weighted sum is less than or equal to a threshold T1, the interpolation quality reliability of the whole frame is regarded as “high reliability”, and the motion-compensated interpolation process is performed. Examples of the fallback interpolation process may include repeating the corresponding pixels from the original frames, and/or averaging the collocated samples from the reference frames. An example calculation that may be performed by reliability, determination module 109 for using a weight sum of reliability metrics to determine whether motion-compensation interpolation or fallback interpolation is used may include the following procedure (11):

| weighted_sum = frame_sad + tmp_frame_mv_var * lambda | |
|---|---|
| if(weighted_sum> T1) | |
| { | |
| frame_interpolation_reliability = low | |
| } | (11). |

else
{
frame_interpolation_reliability = high
}

In another example, through comparing the weighted_sum to different thresholds, the interpolation quality reliability is classified into three categories, such as low, medium and h such as using procedure (12):

| weighted_sum = frame_sad + tmp_frame_mv_var * lambda | |
|---|---|
| if(weighted_sum> T1) | |
| { | |
| frame_interpolation_reliability=high | |
| } | |
| else if (weighted_sum > T2) | (12). |

```
{
  frame_interpolation_reliability=medium
}
else
{
  frame_interpolation_reliability=low
}
```

Here, T2 is another threshold value and T2<T1.

For a frame classified as “medium reliability”, the interpolation quality reliability determination process is further performed at block level such as according to procedure (13):

| block_interpolation_reliability[i][j] = high | |
|---|---|
| if (local_blk_occ_count[i][j] > T3 ) | (13). |

{
block_interpolation_reliability[i][j]=low
}

In some embodiments, reliability determination module 109 may select the reliability threshold values and the lambda values adaptively according to the reliability metrics determined above.

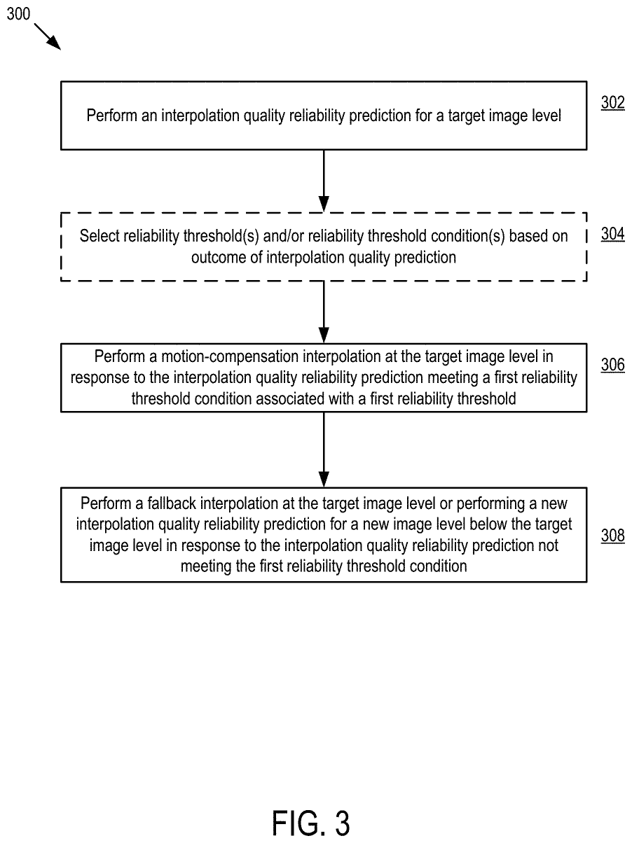

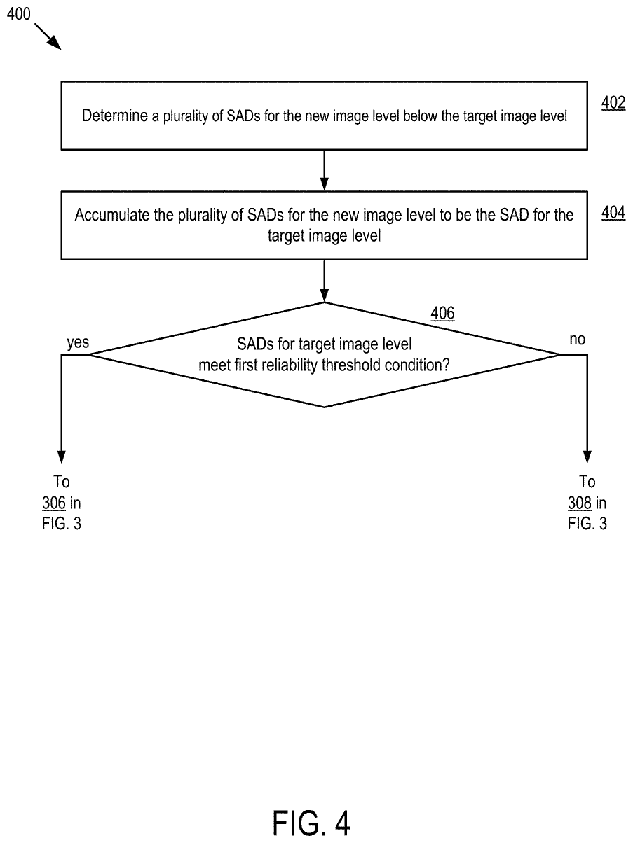

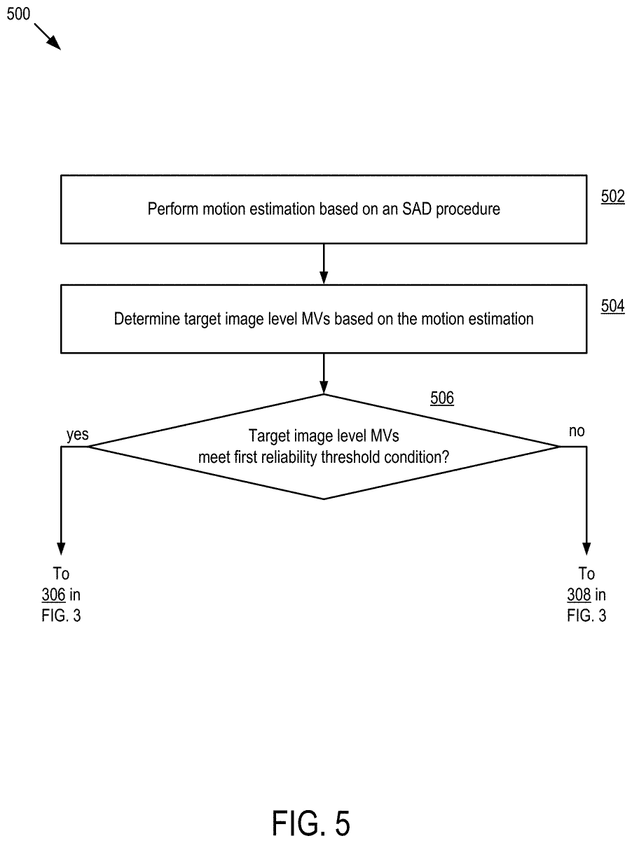

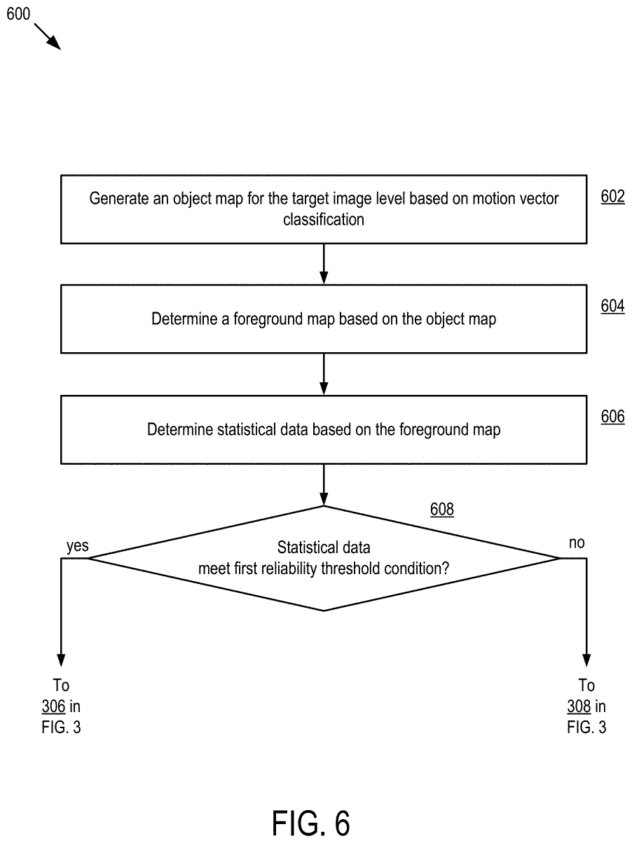

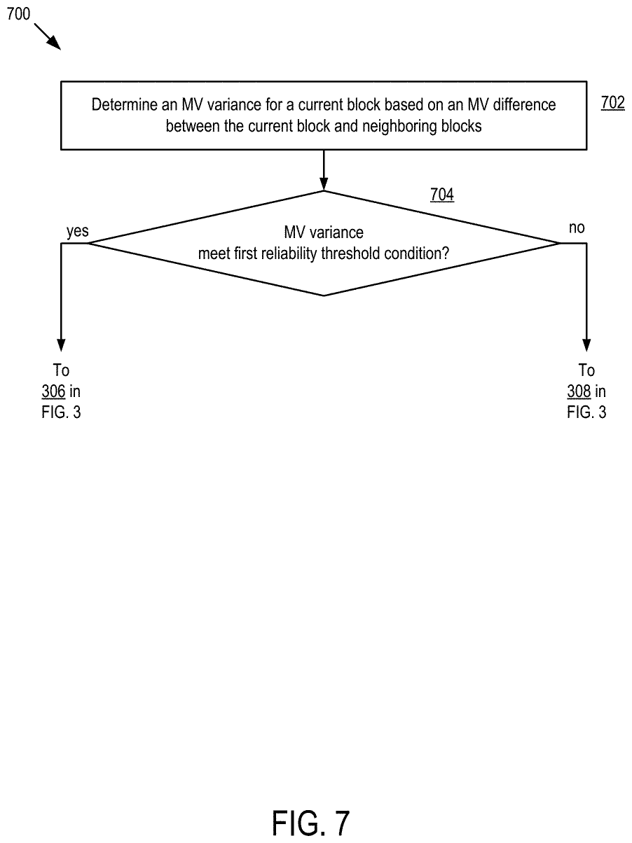

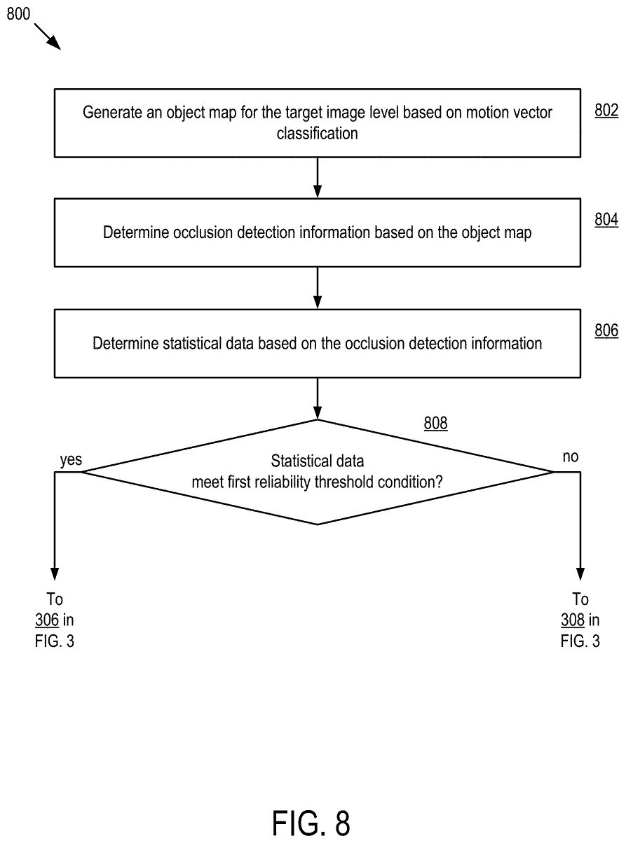

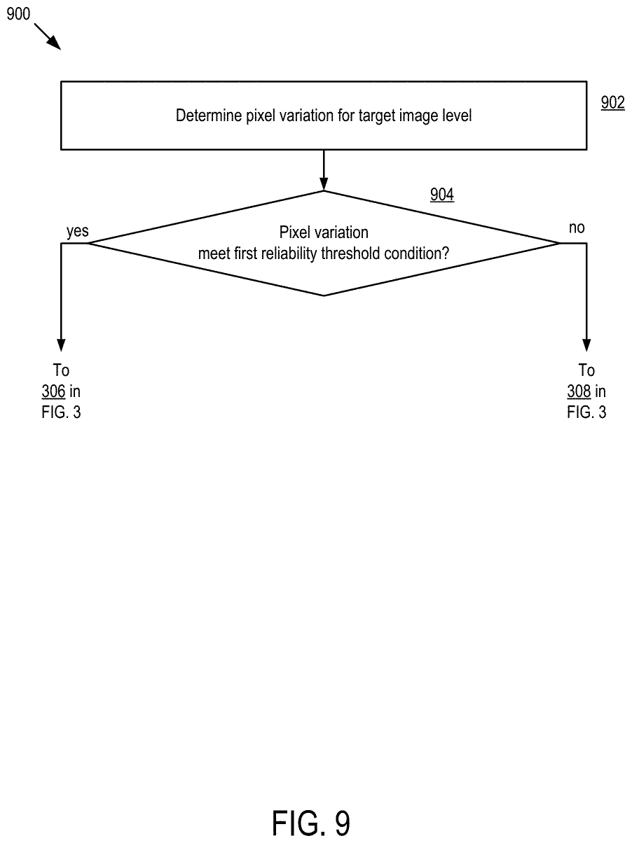

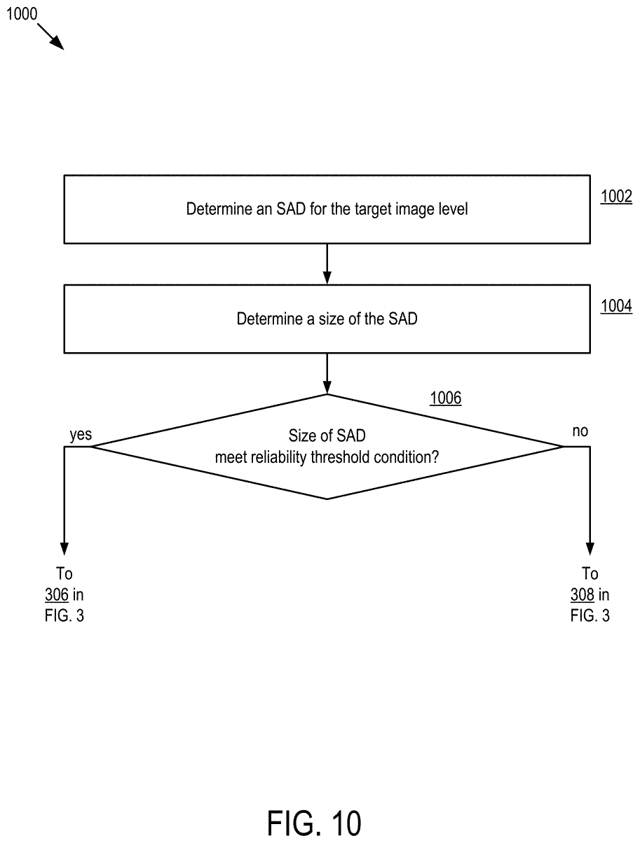

FIG. 3 is a flow chart of an exemplary method 300 for performing FRUC of video data based on a interpolation quality reliability prediction, according to embodiments of the disclosure. Exemplary method 300 may be performed by, e.g., motion estimation module 105, reliability determination module 109, motion compensation module 111, and/or fallback interpolation module 113. Optional operations may be indicated with dashed lines.

Referring to FIG. 3, at 302, reliability determination module 109 may perform an interpolation quality reliability prediction for a target image level (e.g., video sequence level, frame level, frame region level, block level, etc.). The interpolation quality reliability prediction may be implemented based on various data. For example, the data used to implement the present interpolation quality reliability technique may be related to any one or combination of: 1) a block-level or frame-level su of the absolute difference (SAD), 2) block motion vectors (MV's) obtained during a motion estimation process, 3) foreground maps, 4) motion vector (MV) variance, 5) foreground MV variance, 6) occlusion detection, 7) block-level or frame-level activity, 8) a number of SAD blocks of a certain size, 9) a multi-level interpolation quality reliability determination, or 10) an adaptive reliability threshold selected based on the interpolation quality reliability technique, just to name a few. Reliability determination module 109 may implement a interpolation quality reliability prediction for each of these reliability metrics as described below in connection with FIGS. 4-41, for example.

At 304, reliability determination module 109 may select reliability thresholds and/or reliability threshold conditions based on an outcome of interpolation quality prediction performed at 302.

At 306, motion compensation module 111 may perform a motion compensation interpolation at the target image level in response to the interpolation quality reliability prediction meeting a first reliability threshold condition associated with a first reliability threshold, as described below in more detail in connection with FIGS. 4-11.

At 308, fallback interpolation module 113 may perform a fallback interpolation at the target image level or performing a new interpolation quality reliability prediction for a new image level below the target image level in response to the interpolation quality reliability, prediction not meeting the first reliability threshold condition, as described below in more detail in connection with FIGS. 4-11.

FIG. 4 is a flow chart of an exemplary method 400 for performing the interpolation quality reliability prediction of FIG. 3 based on a block-level sum of an absolute difference (SAD) or a frame-level SAD, according to embodiments of the disclosure. Exemplary method 400 may be performed by motion estimation module 105 and/or reliability determination module 109.

Referring to FIG. 4, at 402, motion estimation module 105 and/or reliability determination module 109 may determine a plurality of SADs for the new image level below the target image level.

At 404, reliability determination module 109 may accumulate the plurality of SADs for the new image level to be the SAD for the target image level.

At 406, reliability determination module 109 may determine whether the SADs for the target image level meet a first reliability threshold condition. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level,

FIG. 5 is a flow chart of an exemplary method 500 for performing the interpolation quality reliability prediction of FIG. 3 based on MVs, according to embodiments of the disclosure. Exemplary method 500 may be performed by motion estimation module 105 and/or reliability determination module 109.

Referring to FIG. 5, at 502, motion estimation module 105 and/or reliability determination module 109 may perform motion estimation based on an SAD procedure.

At 504, motion estimation module 105 and/or reliability determination module 109 may determine target image level MVs based on the motion estimation.

At 506, reliability determination module 109 may determine whether the target image level MVs meet a first reliability threshold condition associated with a first reliability threshold. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

FIG. 6 is a flow chart of an exemplary method 600 for performing the interpolation quality reliability prediction of FIG. 3 based on a foreground map, according to embodiments of the disclosure. Exemplary method 600 may be performed by occlusion detector 107 and/or reliability determination module 109.

Referring to FIG. 6, at 602, occlusion detector 107 and/or reliability determination module 109 may generate an object map.

At 604, occlusion detector 107 and/or reliability determination module 109 may determine a foreground map based on the object map.

At 606, reliability determination module 109 may determine statistical data based on the foreground map.

At 608, reliability determination module 109 may determine whether the statistical data meet a first reliability threshold condition associated with a first reliability threshold. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

FIG. 7 is a flow chart of an exemplary method 700 for performing the interpolation quality reliability prediction of FIG. 3 based on a MV variance, according to embodiments of the disclosure. Exemplary method 700 may be performed by motion estimation module 105 and/or reliability determination module 109.

Referring to FIG. 7, at 702, motion estimation module 105 and/or reliability determination module 109 may determine an MV variance for a current block based on an MV difference between the current block and neighboring blocks.

At 704, reliability determination module 109 may determine whether the MV variance meets a first reliability threshold condition associated with a first reliability threshold. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

FIG. 8 is a flow chart of an exemplary method for performing the interpolation quality reliability prediction of FIG. 3 based on occlusion detection, according to embodiments of the disclosure. Exemplary method 800 may be performed by occlusion detector 107 and/or reliability determination module 109.

Referring to FIG. 8, at 802, occlusion detector 107 and/or reliability determination module 109 may generate an object map based on MV classification.

At 804, occlusion detector 107 and/or reliability determination module 109 may determine occlusion detection information based on the object map.

At 806, reliability determination module 109 may determine statistical data based on the occlusion detection information.

At 808, reliability determination module 109 may determine whether the statistical data meet a first reliability threshold condition associated with a first reliability threshold. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

FIG. 9 is a flow chart of an exemplary method 900 for performing the interpolation quality reliability prediction of FIG. 3 based on pixel variation, according to embodiments of the disclosure. Exemplary method 900 may be performed by occlusion detector 107 and/or reliability determination module 109.

Referring to FIG. 9, at 902, occlusion detector 107 and/or reliability determination module 109 may determine pixel variation for the target image level.

At 904, reliability determination module 109 may determine whether the pixel variation meets a first reliability threshold condition associated with a first reliability threshold. In response to determining that the first reliability threshold condition is met, the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

FIG. 10 is a flow chart of an exemplary method 1000 for performing the interpolation quality reliability prediction of FIG. 3 based on SAD size, according to embodiments of the disclosure. Exemplary method 1000 may be performed by motion estimation module 105 and/or reliability determination module 109.

Referring to FIG. 10, at 1002, motion estimation module 105 and/or reliability determination module 109 may determine an SAD for the target image level.

At 1004, motion estimation module 105 and/or reliability determination module 109 may determine a size of the SAD.

At 1006, reliability determination module 109 may determine whether the number of SADs of a particular size meets a first reliability threshold condition associated with a first reliability threshold. In response to determining that the first reliability threshold condition is the operation may proceed to 306 in FIG. 3 and motion compensation module 111 may perform motion-compensated interpolation of the target image level. Otherwise, in response to determining that the first reliability threshold condition is not met, the operation may proceed to 308 in FIG. 3 and fallback interpolation module 113 may perform a fallback interpolation procedure of the target image level.

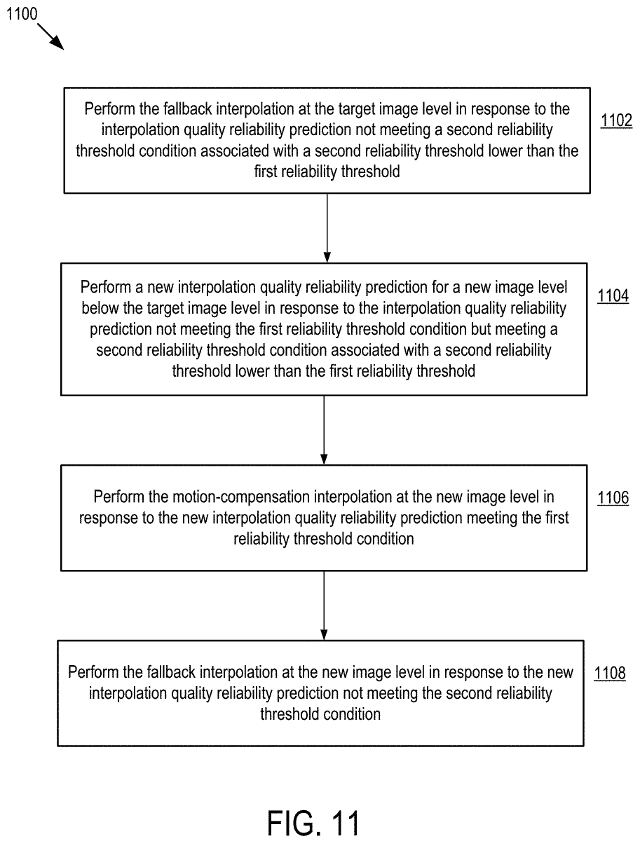

FIG. 11 is a flow chart of an exemplary method for performing the interpolation quality reliability prediction of FIG. 3 based on multi-level reliability classification, according to embodiments of the disclosure. Exemplary method 1100 may be performed by reliability determination module 109, motion compensation module 111, and/or fallback interpolation module 113.

Referring to FIG. 11, at 1102, fallback interpolation module 113 may perform the fallback interpolation at the target image level in response to the interpolation quality reliability prediction not meeting a second reliability threshold condition associated with a second reliability threshold lower than the first reliability threshold.

At 1104, reliability determination module 109 may perform a new interpolation quality reliability prediction for a new image level below the target image level in response to the interpolation quality reliability prediction not meeting the first reliability threshold condition but meeting a second reliability threshold condition associated with a second reliability threshold lower than the first reliability threshold.

At 1106, motion compensation module 111 may perform the motion-compensation interpolation at the new age level in response to the new interpolation quality reliability prediction meeting the first reliability threshold condition.

At 1108, fallback interpolation module 113 may perform the fallback interpolation at the new image level in response to the new interpolation quality reliability prediction not meeting the second reliability threshold condition.

FIG. 12 is a graphical representation illustrating a bilateral-matching motion estimation process 1200, according to embodiments of the disclosure. In some embodiments, a block matching scheme as well as an optical flow scheme can be used to estimate motion vectors of a target frame, and the target frame can be interpolated along a motion trajectory of the motion vectors. The block matching scheme can be easily designed with low computational complexity. The block matching scheme may include a bilateral-matching motion estimation technique, a forward motion estimation technique, or a backward motion estimation technique, etc.

The bilateral-matching motion estimation technique disclosed herein ay be performed for each target block in the target frame to obtain a motion vector of the target block relative to a previous frame and a motion vector of the target block relative to a next frame. In some embodiments, the previous and next frames can be two reference frames closest to the target frame. For example, the previous frame can be a reference frame immediately preceding the target frame with respect to a display order (or time order), and the next frame can be a reference frame immediately subsequent to the target frame with respect to the display order (or time order). In some other embodiments, the previous frame can be any reference frame preceding the target frame, and the next frame can be any reference frame subsequent to the target frame, which is not limited in the disclosure herein.

Referring to FIG. 12, motion estimation module 105 may use the bilateral-matching motion estimation technique to determine motion vectors of a target block 1212 of a target frame 1202 relative to a previous frame 1204a and a next frame 1204b. Specifically, motion estimation module 105 may perform a bilateral matching search process in previous frame 1204a and next frame 1204b to determine a set of candidate motion vectors for target block 1212. The set of candidate motion vectors may include a first pair of candidate motion vectors and one or more second pairs of candidate motion vectors surrounding the first pair of candidate motion vectors. For example, the first pair of candidate motion vectors may include an initial candidate motion vector (iMV0) relative to previous frame 1204a and an initial candidate motion vector (iMV1) relative to next frame 1204b. An exemplary second pair of candidate motion vectors may include a candidate motion vector (cMV0) relative to previous frame 1204a and a candidate motion vector (cMV1) relative to next frame 1204b.

Candidate motion vectors in each pair can be symmetrical. For example, in the first pair, the initial candidate motion vector (iMV0) pointing to previous frame 1204a can be an opposite of the initial candidate motion vector (iMV1) pointing to next frame 1204b. In the second pair, the candidate motion vector (cMV0) pointing to previous frame 1204a can be an opposite of the candidate motion vector (cMV1) pointing to next frame 1204b, A difference between the initial candidate motion vector iMV0 and the candidate motion vector cMV0 can be referred to as a motion vector offset and denoted as MV_offset. For example, the following expressions (14)-(16) can be established for the bilateral-matching motion estimation technique:

cMV0=−cMV1, (14)

cMV0=iMV0+MV_offset, (15)

cMV1=iMV1−MV_offset. (16)

For each pair of candidate motion vectors, two corresponding reference blocks (e.g., a corresponding previous block and a corresponding next block) can be located from previous frame 1204a and next frame 1204b, respectively. For example, for the first pair of candidate motion vectors (iMV0 and iMV1), a previous block 1204 and a next block 1206 can be located for target block 1212 from previous frame 1204a and next frame 1204b, respectively. For the second pair of candidate motion vectors (cMV0 and cMV1), a previous block 1203 and a next block 1207 can be located for target block 1212 from previous frame 1204a and next frame 1204b, respectively.

Next, for each pair of candidate motion vectors (iMV0 and iMV1, or cMV0 and cMV1), a distortion value (e.g., a sum of absolute difference (SAD) values) between the two corresponding reference blocks can be determined. Then, a pair of candidate motion vectors that has a lowest distortion value (e.g., a lowest SAD value) can be determined, and considered as motion vectors of target block 1212 relative to previous frame 1204a and next frame 1204b.

It is noted that a distortion metric is used herein when determining motion vectors of target block 1212 relative to previous and next frames 1204a and 1204b, so that the determined motion vectors can have the best match between two corresponding reference blocks in previous and next frames 1204a and 1204b. Examples of the distortion metric used herein may include, but are not limited to, the following: a SAD metric, a mean square error (MSE) metric, or a mean absolute distortion (MAD) metric.

FIG. 13A is a graphical representation illustrating a forward motion estimation process 1300, according to embodiments of the disclosure. FIG. 13B is a graphical representation illustrating a backward motion estimation process 1350, according to embodiments of the disclosure. Either the forward motion estimation technique or the backward motion estimation technique disclosed herein may be performed for each target block in a target frame to obtain a motion vector of the target block relative to a previous frame and a motion vector of the target block relative to a next frame. In each of the forward and backward motion estimation techniques, different reference blocks are searched only in one of the two reference frames (e.g., either the previous frame or the next frame), while a fixed reference block is used in the other one of the two reference frames.

In some embodiments, in the forward motion estimation technique shown in FIG. 13A, a next block 1318 of a next frame 1304b that is collocated with a target block 1312 of a target frame 1302 is used as a fixed corresponding reference block for target block 1312, while different previous blocks (e.g., including previous blocks 1314, 1316) in a previous frame 1304a are selected as corresponding reference blocks for target block 1312. A distortion value between next block 1318 in next frame 1304b and each of the different previous blocks in previous frame 1304a can be determined. Then, a previous block that has a lowest distortion value can be selected from the different previous blocks, and a motion vector pointing from next block 1318 to the selected previous block can be determined and referred to as MV_{orig_FW}. For example, if previous block 1316 has a lowest distortion value when compared with other previous blocks, the motion vector MV_{orig_FW} can be a motion vector 1340 pointing from next block 1318 to previous block 1316.

The motion vector MV_{orig_FW} can be scaled to obtain a motion vector of target block 1312 relative to previous frame 1304a based on a temporal distance between previous frame 1304a and target frame 1302 and a temporal distance between previous frame 1304a and next frame 1304b. Consistent with the disclosure provided herein, a temporal distance between a first frame and a second frame can be measured as a temporal distance between time stamps (or display orders) of the first frame and the second frame. For example, a motion vector of target block 1312 relative to previous frame 1304a can be calculated by expressions (17)-(18):

MV_{P1}(x)=MV_{orig_FW}(x)*(T_{P1}−T_{target})/(T_{P1}−T_{N1}), (17)

MV_{P1}(y)=MV_{orig_FW}(y)*(T_{P1}−T_{target})/(T_{P1}−T_{N1}). (18)

MV_{P1}(x) and MV_{P1}(y) denote an x component and a y component of the motion vector of target block 1312 relative to previous frame 1304a, respectively. MV_{orig_FW}(x) and MV_{orig_FW}(y) denote an x component and a y component of the motion vector MV_{orig_FW}, respectively. T_{P1}, T_{N1}, and T_{target} denote a time stamp or display order of previous frame 1304a, next frame 1304b, and target frame 1302, respectively. (T_{P1}−T_{target} and (T_{P1}−T_{N1}) denote the temporal distance between previous frame 1304a and target frame 1302 and the temporal distance between previous frame 1304a and next frame 1304b, respectively.

Then, the motion vector MV_{orig_FW} can also be scaled to obtain a motion vector of target block 1312 relative to next frame 1304b based on a temporal distance between next frame 1304b and target frame 1302 and the temporal distance between previous frame 1304a and next frame 1304b. For example, the motion vector of target block 1312 relative to next frame 1304b can be calculated by expressions (19)-(20):

MV_{N1}(x)=MV_{orig_FW}(x)*(T_{N1}−T_{target})/(T_{P1}−T_{N1}), (19)

MV_{N1}(y)=MV_{orig_FW}(y)*(T_{N1}−T_{target})/(T_{P1}−T_{N1}). (20)

MV_{N1}(x) and MV_{N1}(y) denote an x component and a y component of the motion vector of target block 1312 relative to next frame 1304b, respectively. (T_{N1}−T_{target}) denotes the temporal distance between next frame 1304b and target frame 1302.

In some embodiments, in the backward motion estimation technique shown in FIG. 13B, a previous block 1362 of previous frame 1304a that is collocated with a target block 1352 of target frame 1302 is used as a fixed corresponding reference block for a et block 1312, while different next blocks (e.g., including next blocks 1364, 1366) in next frame 1304b are used as corresponding reference blocks for target block 1312. A distortion value between previous block 1362 in previous frame 1304a and each of the different next blocks in next frame 1304b can be determined. Then, a next block that has a lowest distortion value can be selected from the different next blocks, and a motion vector pointing from previous block 1362 to the selected next block can be determined and referred to as MV_{orig_BW}. For example, if next block 1366 has a lowest distortion value when compared with other next blocks, the motion vector MV_{orig_BW} can be a motion vector 1380 pointing from previous block 1362 to next block 1366.

The motion vector MV_{orig_BW} can be scaled to obtain a motion vector of target block 1312 relative to next frame 1304b based on a temporal distance between next frame 1304b and target frame 1302 and a temporal distance between next frame 1304b and previous frame 1304a. For example, the motion vector of target block 1312 relative to next frame 1304b can be calculated by expressions (21)-(22):

MV_{N1}(x)=MV_{orig_BW}(x)*(T_{N1}−T_{target}/(T_{N1}−T_{P1}), (21)

MV_{N1}(y)=MV_{orig_BW}(y)*(T_{N1}−T_{target})/(T_{N1}−T_{P1}). (22)

MV_{orig_BW}(x) and MV_{orig_BW}(y) denote an x component and a y component of motion vector MV_{orig_BW}, respectively. Next, the motion vector MV_{orig_BW} can also be scaled to obtain a motion vector of target block 1312 relative to previous frame 1304a based on a temporal distance between previous frame 1304a and target frame 1302 and a temporal distance between next frame 1304b and previous frame 1304a. For example, the motion vector of target block 1312 relative to previous frame 1304a can be calculated by expressions (23)-(24):

MV_{P1}(x)=MV_{orig_BW}(x)*(T_{P1}−T_{target})/(T_{N1}−T_{P1}), (23)

MV_{P1}(y)=MV_{orig_BW}(y)*(T_{P1}−T_{target})/(T_{N1}−T_{P1}). (24)

It is noted that, when determining motion vectors for a target block using the techniques described in FIGS. 12 and 13A-13B, bias values can also be used in addition to distortion metrics mentioned above so that a more consistent motion vector field can be derived. For example, a spatial correlation between the target block and its neighboring target blocks can be taken into consideration, as well as a temporal correlation between the target block and its collocated reference blocks in the reference frames. Bias values may be calculated based on the differences between a candidate motion vector of the target block and motion vectors from those neighboring target blocks and collocated reference blocks. The bias values may be incorporated into the distortion value (e.g., the SAD value) to determine an overall cost. A candidate motion vector with a lowest overall cost can be determined as a motion vector for the target block.

FIG. 14 is a graphical representation illustrating an exemplary motion vector scaling process 1400, according to embodiments of the disclosure. In some embodiments, when more than two reference frames are used for FRUC, motion estimation module 105 may apply one of the techniques described above with reference to FIGS. 12 and 13A-13B to estimate motion vectors of each target block relative to a first previous frame and a first next frame. The first previous and next frames can be, for example, two nearest reference frames (e.g., a nearest previous frame and a nearest next frame). The nearest previous frame can be a previous frame immediately preceding the target frame. The nearest next frame can be a next frame immediately subsequent to the target frame. Motion vectors of the target block relative to other reference frames can be derived through a motion vector scaling process disclosed herein, without applying any of the techniques of FIGS. 12 and 13A-13B because the techniques of FIGS. 12 and 13A-13B are computationally expensive. It is noted that the motion vectors derived through the motion vector scaling process can also be refined by performing a local motion estimation so that accuracy of the motion vectors can be improved.

Referring to FIG. 14, a target frame 1402 may be located at a position with a display order of i. A plurality of reference frames may include a first previous frame 1404a and a first next frame 1404b located at positions with display orders of i−1, and i+1, respectively. The plurality of reference frames may further include another previous frame 1406 and another next frame 1408 located at positions with display orders of i−k, and i+j, respectively, where k and j are positive integers, and k may or may not be equal to j.

Initially, a motion vector of a target block 1412 relative to first previous frame 1404a (denoted as MV_{P1}) and a motion vector of target block 1412 relative to first next frame 1404b (denoted as MV_{N1}) can be determined by applying any of the techniques of FIGS. 12 and 13A-13B Then, the motion vector MV_{P1} can be scaled to the other previous frame 1406 to determine a motion vector of target block 1412 relative to the other previous frame 1404 (denoted as MV_{P2}) based on a temporal distance between the other previous frame 1406 and first previous frame 1404a and a temporal distance between first previous frame 1404a and target frame 1402. For example, the motion vector MV_{P2} of target block 1412 relative to the other previous frame 1406 can be calculated by expressions (25)-(26):

MV_{P2}(x)=MV_{P1}(x)*(T_{P2}−T_{P1})/(T_{P1}−T_{target}), (25)

MV_{P2}(y)=MV_{P1}(y)*(T_{P2}−T_{P1})/(T_{P1}−T_{target}). (26)

MV_{P1}(x) and MV_{P1}(y) denote an x component and a y component of the motion vector MV_{P1} of target block 1412 relative to first previous frame 1404a, respectively. MV_{P2}(x) and MV_{P2}(y) denote an x component d a y component of the motion vector MV_{P2} of target block 1412 relative to the other previous frame 1406. T_{P2} denotes a time stamp or display order of the other previous frame 1406. (T_{P2}−T_{P1}) denotes the temporal distance between the other previous frame 1406 and first previous frame 1404a.

Then, the motion vector MV_{N1} can be scaled to the other next frame 1408 to determine a motion vector of target block 1412 relative to the other next frame 1408 (denoted as MV_{N2}) based on a temporal distance between the other next frame 1408 and first next frame 1404b and a temporal distance between first next frame 1404b and target frame 1402. For example, the motion vector MV_{N2} of target block 1412 relative to the other next frame 1408 can be calculated by expressions (27)-(28):

MV_{N2}(x)=MV_{N1}(x)*(T_{N2}−T_{N1})/(T_{N1}−T_{target}), (27)

MV_{N2}(y)=MV_{N1}(y)*(T_{N2}−T_{N1})/(T_{N1}−T_{target}). (28)

MV_{N1}(x) and MV_{N1}(y) denote an x component and a y component of the motion vector MV_{N1} of target block 1412 relative to first next frame 1404b, respectively. MV_{N2}(x) and MV_{N2}(y) denote an x component and a y component of the motion vector MV_{N2} of target block 1412 relative to the other next frame 1408. T_{N2} denotes a time stamp or display order of the other next frame 1408, (T_{N2}−T_{N1}) denotes the temporal distance between the other next frame 1408 and first next frame 1404b.

By performing similar operations for each target block in target frame 1402, motion vectors of all the target blocks relative to the other previous frame 1406 and the other next frame 1408 can be determined through the motion vector scaling process, without applying any computationally expensive technique of FIGS. 12 and 13A-13B. As a result, more reference frames (e.g., not only the two nearest reference frames) can be used for performing the FRUC of the video data. In some embodiments, motion compensation module 111 can perform a motion compensation operation using different reference frames adaptively instead of only using the nearest reference frames. For example, a motion compensation operation performed by motion compensation module 111 can be conducted by performing a weighted average on matched blocks from a plurality of reference frames beyond those from the two nearest reference frames.

FIG. 15A is a graphical representation illustrating a process 1500 for generating an exemplary target object map for a target frame, according to embodiments of the disclosure. A target frame 1502, a previous frame 1504a, and a next frame 1504b are shown in FIG. 15A. For example, assuming that two target blocks (shown in an image area 1503 of target frame 1502) may, have a same motion vector relative to previous frame 1504a (e.g., the two target blocks move towards left with a same velocity relative to previous frame 1504a). Other target blocks in the remaining image area of target frame 1502 may have a zero motion vector relative to previous frame 1504a, Then, the two target blocks in image area 1503 can be identified as an object 1508 in a target object map 1520, and the other target blocks in the remaining image area of target frame 1502 can be identified as a background object 1524 in target object map 1520.

In another example, the two target blocks in image area 1503 may have a same motion vector relative to next frame 1504b (e.g., the two target blocks move towards right with a same velocity relative to next frame 1504b). The other target blocks in the remaining image area of target frame 1502 may have a zero motion vector relative to next frame 1504b. Then, the two target blocks in image area 1503 can be identified as object 1508 in target object map 1520, and the other target blocks in the remaining image area of target frame 1502 can be identified as background object 1524 in target object map 1520.

As a result, object 1508 may be identified in image area 1503 of target frame 1502 as a moving object that moves towards left. Background object 1524 can be identified in the remaining image area of target frame 1502. Object 1508 may be assigned with a first relative depth value, background object 1524 may be assigned with a second relative depth value, and the first relative depth value is smaller than the second relative depth value. Target object map 1520 can be generated to include object 1508 and background object 1524.

FIGS. 15B-15D are graphical representations illustrating a generation of an exemplary reference object map for previous frame 1504a of FIG. 15A based on target object map 1520 of FIG. 15A, according to embodiments of the disclosure. Referring to FIG. 15B, occlusion detector 107 may project background object 1524 of target object map 1520 onto previous frame 1504a to generate a first object projection in an image area 1532 of previous frame 1504a. Image area 1532 of previous frame 1504 may be identical to an image area of background object 1524 in target object map 1520, since background object 1524 has a zero-motion vector.

Next, referring to FIG. 15C, occlusion detector 107 may project object 1508 of target object map 1520 onto previous frame 1504a to generate a second object projection in an image area 1533 of previous frame 1504a based on motion vectors of target blocks within object 1508.

Referring to FIG. 150, for image area 1533 of previous frame 1504a where the first and second object projections overlap, the second object projection associated with object 1508 having a smaller relative depth value than background object 1524 is selected, Occlusion detector 107 may determine that image area 1533 of previous frame 1504a is covered by object 1508. As a result, object 1508 is identified in a reference object map 1538 of previous frame 1504a. Each reference block in image area 1533 may have the same relative depth value as object 1508.

For the rest of image area 1532 in previous frame 1504a that is only covered by the first object projection of background object 1524 (e.g., the rest of image area 1532=image area 1532−image area 1533), occlusion detector 107 may determine that the rest of image area 1532 is covered by background object 1524. As a result, background object 1524 is also identified in reference object map 1538 of previous frame 1504a. Since no object projection is generated for an image area 1534 of previous frame 1504a (as shown in FIG. 15C), image area 1534 can be filled by background object 1524. As a result, except in image area 1533, background object 1524 is identified in a remaining image area 1540 of previous frame 1504a (e.g., remaining image area 1540=an entire image area of previous frame 1504a−image area 1533). Each reference block in remaining image area 1540 may be part of background object 1524 and have the same relative depth value as background object 1524,

FIG. 15E is a graphical representation 1550 illustrating a determination of an exemplary occlusion detection result for a target block based on target object map 1520 of FIG. 15A, according to embodiments of the disclosure. For each target block in target frame 1502, occlusion detector 107 may determine an occlusion detection result for the target block. The occlusion detection result may indicate whether the target block is an occluded target block relative to first previous and next frames 1504a and 1504b.

For example, occlusion detector 107 may determine, based on a motion vector of a target block 1552 relative to previous frame 1504a, a previous block 1554 of previous frame 1504a that corresponds to target block 1552. Occlusion detector 107 may determine a relative depth value of previous block 1554 based on a previous object map of previous frame 1504a (e.g., reference object map 1538 in FIG. 150. In this example, the relative depth value of previous block 1554 is equal to a relative depth value of target block 1552, which is the second relative depth value of background object 1524. Next, occlusion detector 107 may determine, based on a motion vector of target block 1552 relative to next frame 1504b, a next block 1556 of next frame 1504b that corresponds to target block 1552. Occlusion detector 107 may determine a relative depth value of next block 1556 based on a next object map of next frame 1504b. In this example, the relative depth value of next block 1556 is equal to the first elative depth value of object 1508, which is smaller than that of target block 1552.

Then, occlusion detector 107 may determine the occlusion detection result for e block 1552 based on the relative depth value of target block 1552, the relative depth value of previous block 1554, and the relative depth value of next block 1556. For example, since the relative depth value of target block 1552 is not greater than the relative depth value of previous block 1554 and is greater than the relative depth value of next block 1556, occlusion detector 107 may determine that target block 1552 is a covered occlusion target block relative to previous and next frames 1504a and 1504b. That is, target block 1552 is revealed in previous frame 1504a but covered in next frame 1504b by object 1508 that has a smaller relative depth value. Occlusion detector 107 may determine that a matched block of target block 1552 is previous block 1554 in previous frame 1504a.

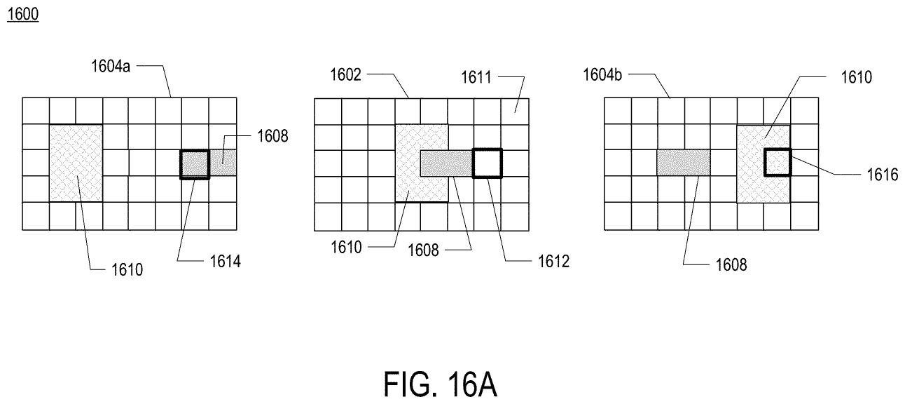

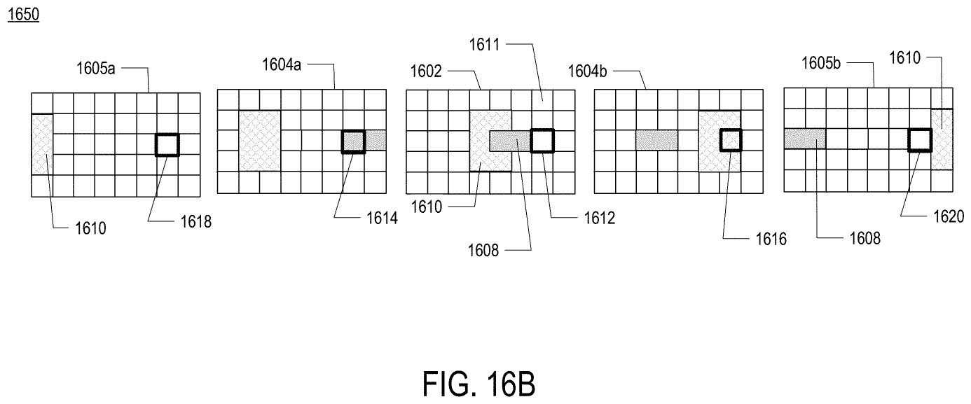

FIG. 16A is a graphical representation illustrating a process 1600 for determining a first occlusion detection result for a target block, according to embodiments of the disclosure. A first previous frame 1604a preceding a target frame 1602 and a first next frame 1604b subsequent to target frame 1602 are shown. Occlusion detector 107 may generate a target object map for target frame 1602 so that objects 1608 and 1610 as well as a background object 1611 are identified in the target object asap. For example, object 1608 with motion towards the left, is identified in two target blocks of target frame 1602 and is assigned with a first relative depth value. Object 1610 with motion towards the right is identified in six target blocks of target frame 1602 and is assigned with a second relative depth value. Background object 1611 with zero motion is identified in remaining target blocks of target frame 1602 and is assigned with a third relative depth value. The first relative depth value is smaller than the second relative depth value, and the second relative depth value is smaller than the third relative depth value.

Occlusion detector 107 may also generate a first previous object map for first previous frame 1604a so that objects 1608 and 1610 as well as background object 1611 are also identified in the first previous object map. Similarly, occlusion detector 107 may generate a first next object map for first next frame 1604b so that objects 1608 and 1610 as well as background object 1611 are also identified in the first next object map.

For each target block in target frame 1602, occlusion detector 107 may determine a first occlusion detection result for the target block. For example, a target block 1612 is covered by background object 1611 in the target object map and may have the third relative depth value. Occlusion detector 107 may determine, based on a motion vector of target block 1612 relative to first previous frame 1604a, a first previous block 1614 of first previous frame 1604a that corresponds to target block 1612. Occlusion detector 107 may determine a relative depth value of first previous block 1614 based on the first previous object map. For example, since first previous block 1614 is covered by object 1608 in the first previous object map, the relative depth value of first previous block 1614 is equal to the first relative depth.

Next, occlusion detector 107 may determine, based on a motion vector of target block 1612 relative to first next frame 1604b, a first next block 1616 of first next frame 1604b that corresponds to target block 1612. Occlusion detector 107 may determine a relative depth value of first next block 1616 based on the first next object map. For example, since first next block 1616 is covered by object 1610 in the first next object map, the relative depth value of first next block 1616 is equal to the second relative depth.

Then, occlusion detector 107 may determine a first occlusion detection result for target block 1612 based on the relative depth value of target block 1612, the relative depth value of first previous block 1614, and relative depth value of the first next block 1616. For example, since the relative depth value of target block 1612 is greater than the relative depth value of first previous block 1614 and also greater than the relative depth value of first next block 1616, occlusion detector 107 may determine that target block 1612 is a combined occlusion target block relative to first previous and next frames 1604a and 1604b. No matched block can be found for target block 1612 from first previous and next frames 1604a and 1604b.

FIG. 16B is a graphical representation illustrating a process 1650 for determining a second occlusion detection result for target block 1612 of FIG. 16A, according to embodiments of the disclosure. A second previous frame 1605a preceding first previous frame 1604a and a second next frame 1605b subsequent to first next frame 1604b are shown and used to determine the second occlusion detection result for target block 1612. Occlusion detector 107 may generate a second previous object map for second previous frame 1605a so that object 1610 as well as background object 1611 are identified in the second previous object map. Similarly, occlusion detector 107 may generate a second next object map for second next frame 1605b so that objects 1608 and 1610 as well as background object 1611 are identified in the second next object map.

Occlusion detector 107 may determine, based on a motion vector of target block 1612 relative to second previous frame 1605a, a second previous block 1618 of second previous frame 1605a that corresponds to target block 1612. Occlusion detector 107 may determine a relative depth value of second previous block 1618 based on the second previous object map. For example, since second previous block 1618 is covered by background object 1611 in the second previous object map, the relative depth value of second previous block 1618 is equal to the third relative depth value of background object 1611.

Next, occlusion detector 107 may determine, based on a motion vector of target block 1612 relative to second next frame 1605b, a second next block 1620 of second next frame 1605b that corresponds to target block 1612. Occlusion detector 107 may determine a relative depth value of second next block 1620 based on the second next object map. For example, since second next block 1620 is covered by background object 1611 in the second next object map, the relative depth value of second next block 1620 is equal to the third relative depth of background object 1611.

Then, occlusion detector 107 may determine a second occlusion detection result for target block 1612 based on the relative depth value of target block 1612, the relative depth value of second previous block 1618, and the relative depth value of the second next block 1620. For example, since the relative depth value of the target block is equal to the relative depth value of second previous block 1618 and the relative depth value of second next block 1620, occlusion detector 107 may determine that target block 1612 is a non-occluded target block relative to second previous and next frames 1605a and 1605b. Matched blocks of target block 1612 can be determined as second previous block 1618 and second next block 1620.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments be apparent to those skilled in the art from consideration of the specification and practice of the disclosed system and related methods.

It is intended that the specification and examples be considered as exemplary only, with a true scope being indicated by the following claims and their equivalents.

1. A computer-implemented method for performing frame rate up-conversion of video data including a sequence of image frames, comprising:
performing, by a video processor, an interpolation quality reliability prediction for a target image level based on a reliability metric;
in response to the interpolation quality reliability prediction meeting a first reliability threshold condition associated with a first reliability threshold, performing, by the video processor, a motion-compensation interpolation at the target image level; and
in response to the interpolation quality reliability prediction not meeting the first reliability threshold condition, performing, by the video processor, a fallback interpolation at the target image level or performing a new interpolation quality reliability prediction for a new image level below the target image level.

2. The computer-implemented method of claim 1, wherein the target image level is one of a sequence of frames level, a frame level, a frame region level, or a block level.

3. The computer-implemented method of claim 1, further comprising:
in response to the interpolation quality reliability prediction not meeting a second reliability threshold condition associated with a second reliability threshold lower than the first reliability threshold, performing, by the video processor, the fallback interpolation at the target image level.

4. The computer-implemented method of claim 1, further comprising:
in response to the interpolation quality reliability prediction not meeting the first reliability threshold condition but meeting a second reliability threshold condition associated with a second reliability threshold lower than the first reliability threshold, performing; by the video processor, the new interpolation quality reliability prediction for the new image level below the target image level;
in response to the new interpolation quality reliability prediction meeting the first reliability threshold condition; performing; by the video processor, the motion-compensation interpolation at the new image level; and
in response to the new interpolation quality reliability prediction not meeting the second reliability threshold condition, performing, by the video processor, the fallback interpolation at the new image level.

5. The computer-implemented method of claim 1, wherein the reliability metric comprises a sum of absolute differences (SAD), and wherein the performing the interpolation quality reliability prediction comprises:
determining a plurality of sum of absolute differences (SADs) for the new image level below the target image level;
accumulating the plurality of SADs for the new image level to be the SAD for the target image level; and
determining whether the SAD for the target image level meets the first reliability threshold condition,
wherein the SADs for the new image level are determined based on a forward SAD procedure, a backward SAD procedure, or a bilateral SAD procedure.

6. The computer-implemented method of claim 1, wherein the reliability metric comprises target image level motion vectors (MVs), and wherein the performing the interpolation quality reliability prediction comprises:
performing motion estimation based on a sum of an absolute difference (SAD) procedure;
determining the target image level MVs based on the motion estimation; and
determining whether the target image level MVs meet the first reliability threshold condition.

7. The computer-implemented method of claim 1, wherein the reliability metric comprises motion vector (MV) variance, and wherein the performing the interpolation quality reliability prediction comprises:
determining an MV variance for a current block based on an MV difference between the current block and neighboring blocks; and
determining whether the MV variance meets the first reliability threshold condition.

8. The computer-implemented method of claim 7, wherein:
the MV variance includes a block-level MV variance or a frame-level MV variance, and
the MV variance includes a spatial MV variance or a temporal MV variance.

9. The computer-implemented method of claim 7, wherein the MV variance includes a foreground MV variance.

10. The computer-implemented method of claim 1, wherein the performing the interpolation quality reliability prediction based on the reliability metric comprises:
generating an object map for the target image level based on motion vector classification;
determining a foreground map based on the object map;
determining statistical data based on the foreground map; and
determining whether the statistical data meets the first reliability threshold condition.

11. The computer-implemented method of claim 10, wherein the statistical data includes a foreground detection reliability or foreground motion vector reliability.

12. The computer-implemented method of claim 1, wherein the reliability metric comprises occlusion detection information, and wherein the performing the interpolation quality reliability prediction comprises:
generating an object map for the target image level based on motion vector classification;
determine occlusion detection information based on the object map;
determining statistical data based on the occlusion detection information; and
determining whether the statistical data meets the first reliability threshold condition.

13. The computer-implemented method of claim 12, wherein the occlusion detection information includes a normal condition, a cover condition, an uncover condition, or a cover-and-uncover condition.

14. The computer-implemented method of claim 1, wherein the performing the interpolation quality reliability prediction based on the reliability metric comprises:
determining a weighted sum of at least two of a sum of an absolute difference (SAD) for the target image level, a foreground map for the target image level, a notion vector (MV) variance for the target image level, a foreground MV variance for the target image level, occlusion detection information, local variation information, or a number of SAD target image level of a threshold size.

15. The computer-implemented method of claim 1, further comprising:
adaptively determining the first reliability threshold based on meta data determined during the interpolation quality reliability prediction.

16. A system for performing frame rate up-conversion of video data including a sequence of image frames, comprising:
a memory configured to store the sequence of image frames; and
a video processor coupled to the memory and configured to:
perform an interpolation quality reliability prediction for a target image level based on a reliability metric;
in response to the interpolation quality reliability prediction meeting a first reliability threshold condition associated with a first reliability threshold, perform a motion-compensation interpolation at the target image level; and
in response to the interpolation quality reliability prediction not meeting the first reliability threshold condition, perform a fallback interpolation at the target image level or performing a new interpolation quality reliability prediction for a new image level below the target image level.

17. The system of claim 16, wherein the target image level is one of a sequence of frames level, a frame level, a frame region level, or a block level.

18. The system of claim 16, wherein the video processor is further configured to:
in response to the interpolation quality reliability prediction not meeting the first reliability threshold condition but meeting a second reliability threshold condition associated with a second reliability threshold lower than the first reliability threshold, perform the new interpolation quality reliability prediction for the new image level below the target image level;
in response to the new interpolation quality reliability prediction meeting the first reliability threshold condition, perform the motion-compensation interpolation at the new image level; and
in response to the new interpolation quality reliability prediction not meeting the second reliability threshold condition, perform the fallback interpolation at the new image level.

19. A non-transitory computer-readable storage medium configured to store instructions which, when executed by a video processor, cause the video processor to perform a process for performing frame rate up-conversion of video data including a sequence of image frames, the process comprising:
performing an interpolation quality reliability prediction for a target image level based on a reliability metric;
in response to the interpolation quality reliability prediction meeting a first reliability threshold condition associated with a first reliability threshold, performing a motion-compensation interpolation at the target image level; and
in response to the interpolation quality reliability prediction not meeting the first reliability threshold condition, performing a fallback interpolation at the target image level or performing a new interpolation quality reliability prediction for a new image level below the target image level.

20. The non-transitory computer-readable medium of claim 19, wherein the process further comprises:
in response to the interpolation quality reliability prediction not meeting the first reliability threshold condition but meeting a second reliability threshold condition associated with a second reliability threshold lower than the first reliability threshold, performing the new interpolation quality reliability prediction for the new image level below the target image level;
in response to the new interpolation quality reliability prediction meeting the first reliability threshold condition, performing the motion-compensation interpolation at the new image level; and
in response to the new interpolation quality reliability prediction not meeting the second reliability threshold condition, performing the fallback interpolation at the new image level.
